(19) United States
(12) Patent Application Publication
(10) Pub. No.: US 2025/0321859 A1
(43) Pub. Date: Oct. 16, 2025

(54) SCANNING APPLICATION CODE TO DETECT AND CLASSIFY SDK DATA UTILIZING A TYPE-BASED ANALYSIS

(71) Applicant: OneTrust LLC, Atlanta, GA (US)

(72) Inventor: Julian Evans, Huntingdon (GB)

(21) Appl. No.: 18/632,903

(22) Filed: Apr. 11, 2024

(51) Int. Cl. G06F 11/36; G06F 21/57

(52) U.S. Cl. CPC G06F 11/3616; G06F 21/577; G06F 2221/033

(57) ABSTRACT

This disclosure describes some aspects of systems, non-transitory computer-readable media, and computer-implemented methods that scans application codes to detect data processing activity components utilized a type-based analysis. For example, the disclosed systems can extract data type information from input application code and utilize the data type information to identify a list of potential (or candidate) function call components for the particular extracted data type. In addition, the disclosed systems can utilize a pattern matching model to match the list of potential function call components to function call component signatures within the application code. Moreover, the disclosed systems can utilize the determined function call component signatures with a detector specification to identify particular data processing activity components (e.g., SDKs, targets, method calls) corresponding to the application code. Moreover, the disclosed systems can display the identified data processing activity components within a software profile for the application code.

### BACKGROUND

Recent years have seen an increasing implementation of computer systems that implement scanning tools to detect functions in application code. Specifically, many entities increasingly utilize scanning tools to analyze source code of an application to identify data processing activities performed by an application. Indeed, such scanning tools are often utilized to identify tracking technologies used by websites and applications. For example, application store platforms (e.g., platforms that deploy applications to various users) often utilize scanning tools and/or manual review to identify tracking technologies (or other data processing activities) present in an application code prior to distributing the application. While scanning tools exist to analyze source code of an application, existing scanning tools are often rigid, limited in coverage, difficult to scale, and inefficient.

To illustrate, in many cases, existing code scanning systems often cannot easily generate useable inferences from application codes. For instance, many conventional systems receive (or analyze) application codes that are large in size (e.g., thousands of lines of code, tens of thousands of lines of code) and often reference various internal and imported libraries, call functions, and data types. In many cases, the application codes often utilize different coding styles, coding languages, syntax, and semantics such that it is difficult to analyze the referenced libraries, call functions, and data types. Accordingly, oftentimes, conventional systems are unable to easily identify various internal and imported libraries due to the variability in coding styles, coding languages, syntax, and semantics. As a result, existing code scanning systems often present components by listing the language utilized in the application code for the components (e.g., a specific software development kit (SDK) library syntax, a call function syntax). This often results in a large list (e.g., thousands) of specific references or calls present in the application code (in an unedited syntax) that are difficult to comprehend and/or meaningfully utilize.

Furthermore, the above-mentioned rigidity of existing code scanning systems also results in computational inefficiencies. For instance, existing code scanning systems often that are unable to easily identify internal and imported libraries due to variability in coding, inefficiently and unintelligently scan an entire application code to create a large list (e.g., thousands) of specific references or calls present in the application code without context (e.g., by simply listing components in an application code after scanning the application code). Indeed, in many cases, existing code scanning systems decompile and extensively scan through thousands of lines of code to identify each and every component present in the application code (e.g., often by listing each component). Such scans often result in an inefficient utilization of computing resources with difficult to comprehend and/or meaningfully utilizable scan results.

In addition to the foregoing, existing code scanning tools are also often difficult (and inefficient) to navigate. Indeed, in many cases, existing code scanning tools result in inefficient user interfaces that are difficult to navigate. To illustrate, many conventional code scanning tools result in a substantially large list of output, detected components. In many cases, such large lists of components are inefficiently listed in a UI by conventional code scanners. As such, conventional code scanning tools often result in UIs that require many navigational steps to review large lists of components. In addition to not easily presenting the breadth of information detected from large application codes within compact UIs, many existing scanning tools also require additional navigation to comprehend the scan results (or listed components). For instance, oftentimes, the existing scanning tool lists components detected within an application code and require users to inefficiently navigate between various libraries and/or search engines to determine the listed components (and the components' purpose).

Additionally, many existing code scanning tools fail to easily scale to or cover a variety of application codes for a variety of classes and methods within the application codes. In particular, existing code scanning tools often attempt to identify static (or known) components in application codes by searching for specific references or calls. In many cases, such existing code scanning tools are unable to identify newly introduced references or calls that are unchecked through the specific references or calls known to the existing code scanning tools without updating the static list of references or calls. As such, conventional code scanning tools are unable to dynamically adapt to newly introduced references or calls within application codes.

In addition to the foregoing, recent surges in data usage have introduced complex challenges for large organizations, particularly concerning data sprawl, which poses significant risks to data security and privacy. Data sprawl, in this context, pertains to the proliferation of independent software applications that handle and store data, including sensitive or personal information. This proliferation makes it challenging to monitor what software applications are tracking what data and the usage of data by software applications, thereby elevating the risk of data breaches and security incidents. One contributor to data sprawl is not knowing what data is being tracked or shared by SDKs of a software application. This is often the result of existing scanning tools providing results that are difficult to identify, comprehend, navigate, and/or meaningfully utilize as described above.

Furthermore, the foregoing problems can be easily exacerbated due to the frequency of software updates. Specifically, frequent software revisioning and updating can lead to changes in data tracking and usage that go undetected. Alternatively, software updates can require re-scanning of a software application and the associated potential millions of lines of code.

These and other problems exist with regard to conventional application code scanning tools.

### SUMMARY

This disclosure describes one or more aspects that provide benefits and solve one or more of the foregoing or other problems in the art with system, non-transitory computer-readable media, and computer-implemented methods that scan application codes to intelligently detect data processing activity components utilized a type-based analysis. In particular, the disclosed systems can utilize data type information extracted from an application code to infer behavior of the application code and data processing activity component information for the application code. For example, the disclosed systems can extract data type information from input application code and utilize the data type information to identify a list of potential (or candidate) function call components (e.g., potential method calls, references) for the particular extracted data type. In addition, the disclosed systems can utilize a pattern matching model to match the list of potential (or candidate) function call components to function call component signatures within the application code. Moreover, the disclosed systems can utilize the determined function call component signatures with a detector specification to identify particular data processing activity components (e.g., SDKs, targets, method calls) corresponding to the application code. In some implementations, the disclosed systems also display the identified data processing activity components categorized by data type or SDK categories within a software profile for the application code.

### BRIEF DESCRIPTION OF THE DRAWINGS

The detailed description is described with reference to the accompanying drawings in which:

FIG. 1 illustrates a schematic diagram of an example environment in which an application scanning service system operates in accordance with some aspects.

FIGS. 2A-2B illustrate an overview of an application scanning service system scanning an application code to determine data processing activity components in accordance with some aspects.

FIG. 3 illustrates an application scanning service system extracting a data type in accordance with some aspects.

FIG. 4 illustrates an application scanning service system identifying candidate function call components in accordance with some aspects.

FIG. 5 illustrates an application scanning service system utilizing pattern matching to determine function call component signatures from an application code in accordance with some aspects.

FIG. 6 illustrates an application scanning service system determining data processing activity components from a detector specification in accordance with some aspects.

FIG. 7 illustrates an application scanning service system displaying information from a scan of an input application code in accordance with some aspects.

FIG. 8 illustrates an application scanning service system displaying determined changes of data processing activity components in accordance with some aspects.

FIG. 9 illustrates an application scanning service system displaying information from a scan of an input application code with SDK categories in accordance with some aspects.

FIG. 10 illustrates a flowchart of a series of acts for scanning an application code to determine data processing activity components for the application code in accordance with some aspects.

FIG. 11 illustrates a block diagram of an example computing device in accordance with some aspects.

### DETAILED DESCRIPTION

One or more aspects of the present disclosure include an application scanning service system that scans an application code utilizing a data type-based analysis to determine data processing activity components present in the application code. For instance, the application scanning service system can extract one or more data types from an application code and utilize the one or more extracted data types to identify one or more candidate function call components that map to the one or more data types. In addition, the application scanning service system can utilize pattern matching on the application code with the one or more candidate function call components to identify one or more function call component signatures from the application code. In addition, the application scanning service system can determine one or more data processing activity components (e.g., as scan results) by utilizing mappings between the one or more function call component signatures and a detector specification (that includes data processing descriptions for particular function call component signatures).

To illustrate, the application scanning service system can scan application code to determine (and display) analysis data objects that represent one or more data processing activity components identified through the scan. To scan the application code, the application scanning service system utilizes a type-based analysis by extracting data types from the application code and using the data types to infer potential function call components via pattern matching and a detector specification. Indeed, the application scanning service system can efficiently, flexibly, and accurately scan an application code utilizing the above-mentioned type-based analysis approach (as described herein) to identify and display represent one or more data processing activity components (e.g., SDKs, method calls, references) identified through the scan of the application code.

In one or more aspects, the application scanning service system utilizes a code parser to extract type information from an application code. For instance, the application scanning service system can parse application code to identify data types indicated (or associated) with the application code. As an example, the application scanning service system can identify data types being processed and/or utilized by the application code, such as, but not limited to, location data (e.g., approximate location, precise location data), user identifier data (e.g., device ID data), and/or personal identifiable identifier data (e.g., name, email, user account, address).

Additionally, the application scanning service system can utilize the identified data types corresponding to the application code to determine (or generate) a list of potential (or candidate) function call components. For instance, the application scanning service system can utilize a mapping between data types and one or more potential function call components to select (or determine) a list of potential function call components. As an example, the application scanning service system can determine that a data type of location data maps to candidate function call components, such as “getLocation( ),” “getGPS( ),” “accessGPS( ),” and/or getAddress( );.” Indeed, the application scanning service system can determine a list of multiple candidate function call components for a data type.

Furthermore, in one or more aspects, the application scanning service system can utilize a pattern matching model to identify function call component signatures in the application code. In particular, the application scanning service system can compare code (or components represented by code) from the application code to the candidate function call components to identify component signatures from the application code that are similar to the candidate function call components. Indeed, in some instances, the application scanning service system utilizes a list of multiple candidate function call components for one or more data types to match to multiple candidate function call component signatures in the application code (e.g., method signatures, reference signatures).

In addition, the application scanning service system can utilize the one or more identified function call component signatures to determine data processing activity components that are present in the application code. For instance, the application scanning service system can identify data processing activity components, such as, but not limited to, SDK components, application programming interface (API) components, and/or other function call components. To illustrate, in one or more aspects, the application scanning service system utilizes a detector specification to determine mappings between the identified function call component signatures and entries in the detector specification. Indeed, as an example, the entries in the detector specification can include a namespace for a particular data processing activity component (based on the function call component signature), a data processing description for the data processing activity component, and/or metadata for the data processing activity component. In some instances, the application scanning service system also determines a vulnerability flag and/or security flag corresponding to the data processing activity component from the detector specification. The application scanning service system can utilize the data from the detector specification to generate analysis data objects (which include the data processing activity components) in response to the application code scan.

Additionally, the application scanning service system can generate various graphical user interfaces to display output analysis data objects for the application code scan. In one or more aspects, the application scanning service system generates graphical user interfaces that indicate the data processing activity components utilized (or present) in the application code (via the analysis data objects). For instance, the application scanning service system can display the data processing activity components, data processing description for the data processing activity components, and/or metadata for the data processing activity components. In some cases, the application scanning service system can display an indication of the types of data being processed by an application code, such as, but not limited to, location data, computing device data, demographic data, hit-level data, cookie data, and/or device usage data. Furthermore, the application scanning service system can display an indication of data processing purpose types implemented in the application code, such as, but not limited to, application functions, advertisement targeting processes, data aggregation processes, and/or debugging processes.

The disclosed application scanning service system provides several advantages over conventional systems. In contrast to many existing scanning tools that cannot easily generate useable inferences from application codes, the application scanning service system can intelligently scan a wide variety of application codes regardless of the size of the application codes. In particular, by utilizing potential function call components determined from data types detected in an application code to match with function call component signatures in an application code, the application scanning service system can easily and flexibly identify relevant (or meaningful) components from an application code even when the application code varies in coding style, syntax, language and/or is large in size. Indeed, unlike conventional systems that often generate large lists of components present in an application code, the application scanning service system can dynamically and intelligently detect components that are relevant to identified data types. This results in a focused application scan even when the application code is large in size (e.g., thousands of lines of code, tens of thousands of lines of code) and/or varies in coding styles, coding languages, syntax, and semantics. In addition, due to the flexibility in scanning, the application scanning service system can also cover a wide variety of application codes without modification and/or user intervention in the scanning process.

Furthermore, the application scanning service system can identify components (within application code) that do not have reference indicators via the data type analysis approach described above. For instance, in some cases, internal references in application code may not indicate a reference SDK. Unlike many existing scanning systems tools that would be unable to identify the reference SDK, the application scanning service system can identify the components without references to class (or method) names in the application code and accurately determine a referencing SDK for the components.

Additionally, in contrast to many existing scanning tools that attempt to identify static components in application codes by searching for specific references or calls, the application scanning service system improves scalability. Indeed, the application scanning service system can dynamically use candidate function call components to pattern match with similar components to identify function call component signatures from an application code (e.g., without searching for static word-for-word references or calls). Furthermore, the application scanning service system can map the function call component signatures to a detector specification that includes various data processing activity components and corresponding information for the data processing activity components. This enables the application scanning service system to scale to new data types, data processing activity components, and/or application codes instead of being constrained to particular static references or calls.

Additionally, as mentioned above, many conventional code scanning tools are often difficult (and inefficient) to navigate. In contrast, the application scanning service system generates graphical user interfaces with application code scan results that easily and quickly enable access to data processing activity components detected for the data types. In particular, the application scanning service system condenses large lists of data processing activity components from an application code scan within categories corresponding to data types. In many cases, the application scanning service system generates such graphical user interfaces to reduce inefficient user navigation between various libraries, a scan result UI, and/or search engines to determine the listed components (and the components' purpose).

Furthermore, the application scanning service system enables various improvements in user interface navigation for application code scans. For instance, the application scanning service system can generate graphical user interfaces that enable quicker (and efficient) navigation to detect data processing activity component changes between versions of an application code. To illustrate, in many conventional systems, users are unable to determine differences between detected data categories or data processing activity components between multiple versions of an application code without manually navigating in between multiple scans of the multiple versions of the application code. In contrast, the application scanning service system can determine and display data processing activity component changes between versions of an application code to enable efficient insight into the detected scanning differences without navigation between different scan reports of multiple versions of the application code. Moreover, unlike conventional systems, the application scanning service system also generates software profiles that track in which version a data processing activity component (or data type) was changed (e.g., added or removed) to provide efficient insight between more than two application code scans in a single graphical user interface (i.e., a single scan report interface).

Indeed, the application scanning service system, via the application code scan, provides a practical application that allows for efficient application code modifications in light of changes in data privacy management and/or data privacy laws. To illustrate, in many cases, application administrators or developers may change (or modify) application code to address frequent updates in data privacy management and/or data privacy law. Oftentimes, in response to such updates, many conventional systems require administrators or developers to identify portions of an application code that relate to the updated data management policies and/or laws through a tedious and time consuming review of the application code. Unlike such conventional systems, the application scanning service system utilizes detected data processing activity components and/or data types (with tagged location data) to enable quick navigation to a portion of the application code that relates to the updated data management policies and/or data laws. In addition, the application scanning service system can also enable development tools to efficiently navigate to the portions of the application codes to allow administrators and/or developers to modify the application code to reflect the updated data management policies and/or data laws. In some cases, the modifications can be a result of the application scanning service system providing vulnerability flags for particular identified components.

In many cases, the application scanning service system scans application codes to generate graphical user interfaces with practical applications. For instance, the application scanning service system generates graphical user interfaces with detected data processing activity components to enable detection of the components existing within (often large) application codes for data privacy applications and/or software application audits. Indeed, in some cases, the application scanning service system utilizes the detected data processing activity components and/or data types for compliance determinations (e.g., to detect for certain types of data processing within application codes). For instance, in some instances, a software deployment platform system utilizes outputs and/or user interfaces of the application scanning service system to detect data processing activities within an application code prior to distributing a software application. This enables the developer to understand what data is being tracked/used by a software application prior to deploying the software application. This in turn allows the software deployment system to manage consent of users who will access the software application. In some cases, the application scanning service system enables displaying of the detected data processing activity components and/or data types within the software deployment platform system user interfaces to enable users to view data processing activities within an application code prior to downloading an application.

Additionally, certain aspects of the application scanning service system improve the accuracy of computing systems that manage digital data trackage/usage in accordance with requirements for various data policies. In particular, the application scanning service system utilizes data types and data processing purpose types detected in an application code in connection with any number of data policies and data assets to accurately determine relationships between the data policies and software application use of data. In particular, by classifying data categories and data processing purpose types in relation to the data policies, the application scanning service system can automatically detect that specific code lines or SDKs of an application code that violate a particular data policy. In particular, the application scanning service system leads to faster data access times and reduces the computational load spent searching for code or SDKs relevant to one or more data policies.

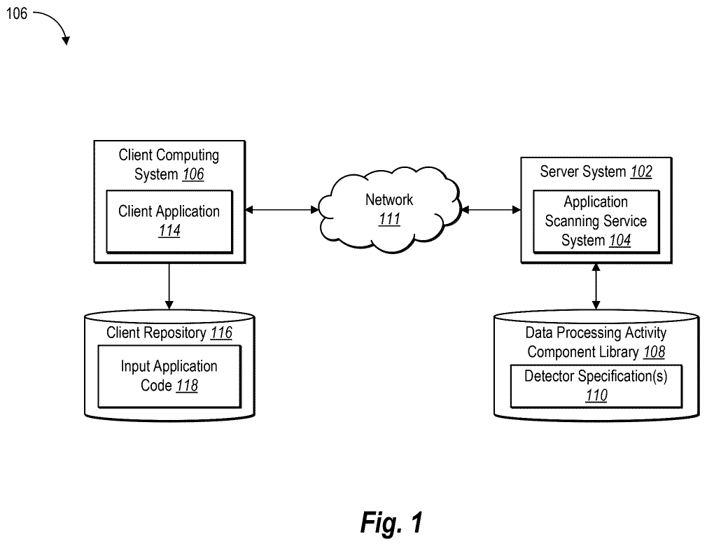

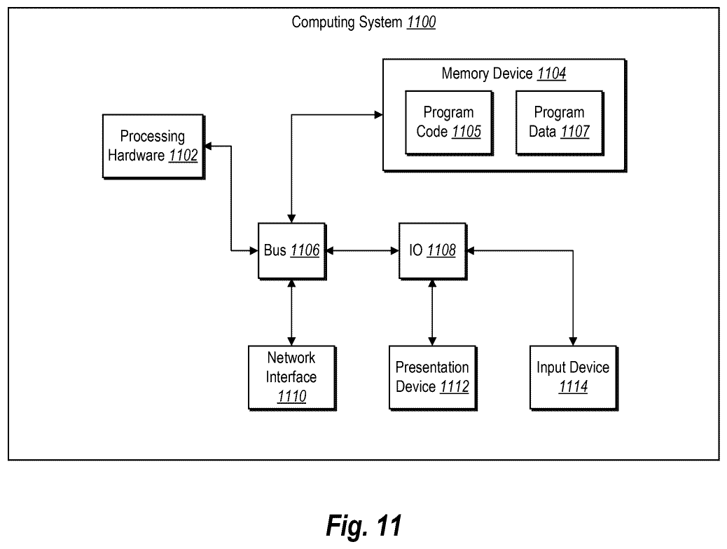

Turning now to the figures, FIG. 1 illustrates a schematic diagram of a system environment in which an application scanning service system 104 can operate in accordance with one or more aspects. Indeed, FIG. 1 depicts an example of an application scanning service system 104 that includes a server system 102 and a client computing system 106. In the example environment depicted in FIG. 1, software components in the server system 102 are communicatively coupled with software components in the client computing system 106. In one or more aspects, the server system 102 can operate on a server device(s). Indeed, the server device(s) can include variety of types of computing devices, including those described with reference to FIG. 11.

As shown in FIG. 1, the server system 102 (via a server device) includes an application scanning service system 104. Indeed, the application scanning service system 104 can enable an application scanning service to scan an application code to determine data processing activity components for the application code utilizing a type-based analysis (as described herein).

As used herein, the term “application code” refers to a set of instructions (or commands) that execute an application (e.g., a software, computer program). In particular, the term “application code” can refer to a set of text (e.g., source code) representing instructions that compile and/or assemble to a machine-readable format that is executable as a digital application. For example, an application code can include software source code, object code, a mobile phone application package (e.g., an Android Package Kit (APK) files, IPA files), and/or markup scripts, such as, but not limited to, C++ code, Java code, Python scripts, Javascript, HTML, and/or binary assembly code. In some cases, an application code can include a collection of multiple software source code, object code, and/or markup scripts to represent function calls, data, variable SDKs, APIs, and/or other libraries involved in an application.

Furthermore, as used herein, the term “data processing activity component” refers to a reference, instruction, or object within an application code that causes the performance of one or more actions associated with data. In some cases, the data processing activity component includes a data processing operation including, but not limited to, a computing process or action corresponding to execution of processing instructions to process, collect, access, store, retrieve, modify, or delete target data. To illustrate, a data processing activity component can include, but is not limited to, a software development kit (SDK) component, mobile SDK, application programming interface (API) component, website cookies, website functions, or function call component within an application code (that enables processing, collecting, accessing, storing, retrieving, modifying, or deleting data).

In addition, as described herein, the application scanning service system 104 can determine, from an application code, one or more data types. As used herein, a “data type” refers to a particular kind of data object defined by values represented by the data object and/or operations performed on the data object. For example, a data type can include a representation of values and/or information indicated by a particular data object. For instance, a data type includes, but not is not limited to, location data, cookie data, camera data, demographic data, computing device data, device usage data, hit-level data, biometrics data, personal identifiable information (PII) data, purchase data, financial data, media data, health data, and/or application performance data.

Additionally, the application scanning service system 104 includes automation and intelligence features for scanning input applications to detect data processing activities performed by or facilitated by the input applications. For instance, input applications, such as a mobile application, a web application, a website, or connected TV application, often include data processing activity components, such as, but not limited to software development kit (“SDK”) components, APIs, and/or other functions. Such data processing activity components (e.g., SDK components implemented for the input application) can be configured to collect, store, or otherwise use data associated with an end user interacting with (and/or a user device operating) the input application (e.g., user behavior, preferences, device location, device usage data, etc.).

Furthermore, the application scanning service system 104 can scan and categorize such data processing activity components (e.g., the SDK functionality) in the input application, including functionality that is unknown to a developer of the input application. In one or more aspects, the application scanning service system 104 can scan an input application (to determine data processing activity components as described herein) to facilitate any appropriate modifications to the input application (e.g., updates to reduce or restrict data collection activities). Moreover, the application scanning service system 104 can scan an input application (to determine data processing activity components) to disclose and/or detect (known and/or unknown) operations performed by the input application (e.g., to the operator of a third-party application deployment platform via which the input application will be provided to end users).

In one or more aspects, as shown in FIG. 1, the application scanning service system 104 can be implemented (as described herein), in whole or in part, within the server system 102 (via an application scanning service). In some aspects, the application scanning service system 104 can be implemented (as described herein), in whole or in part, within the client computing system 106 (e.g., via a client application 114).

The server system 102 also includes one or more repositories that can store one or more data processing activity component libraries (e.g., SDK libraries, API references). For instance, as shown in FIG. 1, the data processing activity component library 108 can include one or more detector specification(s) 110 for various data processing activity components. Indeed, in some aspects, the data processing activity component library 108 includes detector specification(s) 110 for a set of data processing activity components (e.g., identifiers for the components and descriptive data for the components as described herein). As an example, the data processing activity component library 108 can include one or more SDK libraries with one or more detector specifications for the SDKs. Additionally, in one or more cases, the data processing activity component library 108 can include one or more API references with one or more detector specifications for the APIs and/or one or more scripting language (e.g., Python, Javascript) functions with one or more detector specifications for the one or more scripting language functions.

Furthermore, as used herein, the term “detector specification” refers to mappings between one or more data processing activity component identifiers and descriptive data for the data processing activity component identifiers. For example, a detector specification can include identifiers that indicate a particular data processing activity component, such as, but not limited to, a signature, a namespace, a hash, and/or a text string corresponding to the data processing activity component. In addition, the detector specification can include descriptive data for the data processing activity components to represent various aspects of the data processing activity components. For instance, the detector specification can include descriptive data such as, but not limited to, a data category type, one or more identifiers for the component, source information, a description of the component to describe a purpose of the data processing, device access permissions, variables and data types utilized in the component, and/or a version of the component. Indeed, the application scanning service system utilizes a detector specification to map data processing activity component identifiers detected within an application code to extract and/or assign descriptive data (e.g., data categories or types, purpose of data processing) to specific data processing activity components in the application code. In one or more aspects, a detector specification includes a decision tree, a data object entry (e.g., a JSON entry, a CSV entry), a database entry, a relational graph that creates connections between data processing activity components and descriptive data.

In one or more aspects, the application scanning service system 104 scans an input application code 118 to determine data types and identify candidate function call components for the input application. Then, in one or more aspects, the application scanning service system 104 utilizes the candidate function call components to identify matching patterns in the application code to determine one or more function call component signatures within the application code. Furthermore, the application scanning service system 104 can utilize the function call component signatures with a detector specification 110 to determine one or more data processing activity components.

In particular, as mentioned above, the detector specification 110 can include mappings between defined features of a data processing activity component and an identifier for the data processing activity component (e.g., the function call component signatures). The application scanning service system 104 can scan the input application code 118 to identify one or more function call component signatures and search the detector specification 110 to determine (or generate) one or more defined data processing activity components for the one or more function call component signatures.

In some instances, a detector specification 110 can include data processing activity component identifying search criteria (e.g., an identifier or signature), such as one or more network addresses (e.g., a Uniform Resource Locator (“URL”)) and/or a namespace that could be included in the code of an input application, one or more methods names that could be included in or otherwise invoked by in the code of an input application, whether a method is called by first-party code (e.g., functions defined within the input application) or third-party code (e.g., functions defined by an external library used by the input application). The detector specification 110 can also include, mapped to a particular feature in the search criteria (e.g., a data processing activity component signature or function call component signature), metadata indicating descriptive data for the data processing activity component such as, but not limited to, data types for the particular data processing activity component signature and/or descriptors for the particular data processing activity component signature.

As an example, the application scanning service system 104 can utilize a detector specification represented through a structure file that includes data processing activity component identifiers (e.g., function call component signatures) and descriptive data for the data processing activity components. For instance, Table 1 (below) illustrates an example of a detector specification as a structure file. In this example, the detector specification includes a structured document (e.g., a JSON formatted file) an “SDK” object (e.g., a data processing activity component object with various metadata, including data categories). In some aspects, as shown in Table 1, the application scanning service system 104 can utilize detector objects (e.g., detector specification entries) from a detector specification to identify and extract information for a data processing activity component. Furthermore, the Table 1 also includes a description of the JSON SDK object and the detector object within the detector specification.

In Table 1, the SDK object in the detector specification defines a list of one or more SDK namespaces for an SDK. For example, the “namespace” can include a top-level package name of an SDK. Furthermore, as shown in Table 1, classes in the SDK can be included in one or more namespaces below the top-level namespace. In response to the application scanning service of the application scanning service system 104 determining a function call component signature from the input application code, the application scanning service system 104 can detect a declaration of this top-level namespace for the SDK mapped to the function call component signature (e.g., as a method name, class name) to determine that the SDK is in the input application code.

TABLE 1
Detector Specification Example

| Example | Description |
|---|---|
| “sdk”: { | In this example, the “name” is an identifier of the SDK |
| “name”: “company1.com Library”, | (e.g., “company1.com Library”) that the application |
| “namespace”: “com. | scanning service system 104 can include in a scan report |
| company1.vs.mobile.library”, | displayed on an end user device. Furthermore, the |
| “description”: “ company1.com, an e- | “namespace” section can define, for each namespace, the |
| commerce company, solves some of the | namespace as it would be included in the code of an input |
| biggest challenges in search and | application (e.g., “com.company1.vs.mobile.library”). In |
| advertising. We focus on helping people | this example detector specification entry, the “category” |
| find the things they want.”, | section identifies a data category for the SDK to be |
| “category”: “Cookie Category” | included in a scan report (e.g., “Cookie Category”). In |
| } | addition, the application scanning service system 104 can |
| | utilize the namespace, name, and/or targets (e.g., method |
| | calls) as signatures (e.g., function call component |
| | signatures). |
| “detectors”: [ | A detector object, as shown in the “detectors” section, can |
| { | include an internal identifier utilized by the application |
| “uuid”: “2e3fe892-1cc5-4916- | scanning service system 104 to identify a particular |
| 896e-138a73ab8bc6”, | detector specification in a scan result (e.g., “uuid”: |
| “category”: “LOCATION”, | “2e3fe892-1cc5-4916-896e-138a73ab8bc6” can |
| “purpose”: “ANALYTICS”, | correspond to a detector specification). Additionally, as |
| “targets”: [ | shown in the example, the detector object can also include |
| { | one or more of: |
| “className”: | a “category” (e.g., “LOCATION”) identifying the |
| “com.company1.vs.mobile | data category for data collected by the target data |
| .library.impl.jni.LocationS | processing activity component functionality |
| uggestion”, | (associated with the text of the data processing |
| “methodName”: | activity component) and/or |
| “getLocation”, | a “purpose” (e.g., “ANALYTICS”) identifying a |
| “dataType”: | purpose for which the target data processing |
| “APPROX_LOCATION” | activity component functionality collects the data. |
| }, | A detector specification entry in this section can also |
| { | include one or more target functionalities, such as method |
| “className”: | names and their class as included in the code of an input |
| “com.company1.vs.mobile | application (e.g., a target functionality having a class name |
| .library.impl.jni.ObjectInf | “com.company1.vs.mobile.library.impl.jni.ObjectInfo” |
| o”, | and method name “getLocation”), as well as a specific |
| “methodName”: | data type in the data category (e.g., |
| “getLocation”, | “APPROX_LOCATION”). Indeed, in some cases, the |
| “dataType”: | application scanning service system 104 utilizes the target |
| “APPROX_LOCATION” | functionalities as function call component signatures. |
| } | |
| ] | |

In some cases, in reference to Table 1, the application scanning service system 104 can utilize an index from a third-party SDK manager (and/or software deployment platform) to classify or identify various SDKs (or other data processing activity components). For instance, the application scanning service system 104 can integrate, as part of the detector specification, a third-party index (from a third-party software deployment platform) that includes one or more data processing activity components (e.g., SDKs) recognized by the third-party software deployment platform. Indeed, the application scanning service system 104 can utilize the data processing activity components from the third-party index as part of the detector specification to identify the data processing activity components in an application scan (in accordance with one or more implementations herein).

In reference to the example in Table 1, the application scanning service system 104 can generate internal identifiers for data processing activity components from identifiers for the data processing activity components. For example, the application scanning service system 104 can generate and/or utilize a universally unique identifier (“UUID”) by transforming one or more identifiers, such as namespaces and/or text of methods into unique identifier values. As an example, the application scanning service system 104 can generate a hash from information in one or more detector specification entries (e.g., detector identifier or from a combination of the detector group and detector identifiers) related to a particular data processing activity component. For example, the application scanning service system 104 can generate a UUID (e.g., an internal identifier) by generating a hash from a namespace within the detector specification entry for a data processing activity component.

As used herein, the term “signature” refers to a sequence of strings that represents a component of an application code. For instance, a function call component signature can include a sequence that represents a target, method, and/or reference name utilized within an application code. In some cases, a function call component signature can include an identifier for a target, method, and/or reference name utilized within an application code. As an example, a function call component signature can include sequences (or strings), such as, but not limited to, “getName( )” “getUserIdentity( )” and/or “getEmail( )” In some cases, the application scanning service system 104 utilizes namespaces, identifiers, and/or target names from a detector specification as a signature.

Moreover, in one or more instances, the application scanning service system 104 determines whether a data processing activity component corresponds to (or represents) a sensitive data collection function call component (e.g., a method call or target). In particular, the application scanning service system 104 can rank (or rate) a sensitivity of data collection for one or more data processing activity components based on data types corresponding to the data processing activity components. For instance, the application scanning service system 104 can assign scores (e.g., 0 to 100, 0 to 1) to different data types and utilize the assigned scores to determine a data sensitivity score for a data processing activity component. Moreover, the application scanning service system 104 can determine (or flag) a data processing activity component as corresponding to sensitive or highly-sensitive data category based on the data sensitivity score. For instance, the application scanning service system 104 can flag a data processing activity component as corresponding to a sensitive data category based on a data sensitivity score corresponding to the data processing activity component satisfying a first data sensitivity threshold. In addition, the application scanning service system 104 can further flag a data processing activity component as corresponding to a highly-sensitive data category based on the data sensitivity score corresponding to the data processing activity component satisfying an additional, second data sensitivity threshold (e.g., greater than the first data sensitivity threshold).

As an example, the application scanning service system 104 can assign a score of 80 to a data type of approximate location and a score of 95 to a data type of photos. Moreover, upon identifying a data processing activity component corresponding to a data type of approximate location, the application scanning service system 104 can assign a score of 80 to the data processing activity component. Based on determining that the data processing activity component corresponding to the data type of approximate location (with a score of 80) satisfies a data sensitivity threshold, the application scanning service system 104 can label or indicate that the data processing activity component processes sensitive data. As another example, the application scanning service system 104 can identify another data processing activity component corresponding to a data type of photos, the application scanning service system 104 can assign a score of 95 to the data processing activity component. Based on determining that the data processing activity component corresponding to the data type of photos (with a score of 95) satisfies a high data-sensitivity threshold (e.g., a second threshold), the application scanning service system 104 can label or indicate that the data processing activity component processes highly-sensitive data. In some cases, the application scanning service system 104 can determine and/or indicate that a data processing activity component corresponds to highly sensitive data based on determining that the data processing activity component is associated with multiple sensitive data types (e.g., approximate location and email, name and address, photos, name, and address).

Furthermore, Table 2 includes an additional example of a detector specification. In Table 2, the detector specification includes a structured document (e.g., a JSON formatted file) having an “SDK” object and a detector object (e.g., a detector specification entry) from a detector specification. For instance, as shown in Table 2, the SDK object section defines a list of one or more SDK namespaces for an SDK. In addition, as shown in Table 2, the SDK object section also includes classes in the SDK that are in one or more namespaces below the top-level namespace of the SDK. As an example, in response to the application scanning service system 104 detecting a function call component signature that represents a declaration of a top-level (or nested) name space in an input application, the application scanning service system 104 can determine that the SDK (corresponding to the SDK object) is in the input application.

TABLE 2
Detector Specification Example

| Example | Description |
|---|---|
| “sdk”: { | In this example, the “name” is an identifier of the |
| “name”: “Adjust SDK”, | SDK (e.g., “Adjust SDK”) that the application |
| “namespaces”: [ | scanning service system 104 can be included in a |
| { | scan report displayed to an end user device. |
| “id”: “adjustAdvertisingNetwork”, | Furthermore, the “namespaces” section defines, for |
| “name”: “Adjust Ad Network SDK for | each namespace: |
| Phone OS”, | the namespace as it would be included in |
| “description”: “Industry leader in | code of an input application (e.g., |
| mobile measurement and fraud prevention.”, | “com.adjust.sdk”), |
| “namespace”: “com.adjust.sdk”, | an internal identifier used by the application |
| “category”: “ Cookie Category ”, | scanning service system 104 to identify the |
| } | namespace within a scan result (e.g., |
| ] | “adjustAdvertisingNetwork”), |
| } | an external identifier (e.g., “Adjust Ad |
| | Network SDK for Phone OS”) and |
| | description (e.g., ““Industry leader in . . .”) |
| | that the application scanning service system |
| | 104 can include in a scan report displayed |
| | to an end user device, and/or |
| | a data category for the SDK that the |
| | application scanning service system 104 can |
| | include in the scan report (e.g., “Cookie |
| | Category”). |
| “detectorGroups”: [ | In this example, each detector object entry (e.g., |
| { | “detectorGroups”) includes: |
| “id”: “adjustAdSdk”, | an internal identifier utilized by the |
| “name”: “Adjust SDK”, | application scanning service system 104 to |
| “detectors”: [ | identify the detector entry (or group) within |
| { | a scan result (e.g., “adjustAdSdk”) and/or |
| “id”: “adjustDeviceId”, | an external identifier that the application |
| “name”: “Device identifiers”, | scanning service system 104 can include in |
| “description”: “This detection has found a | a scan report displayed to an end user (e.g., |
| user's device info, mobile device Wi-Fi MAC | “Adjust SDK”). |
| (translated and untranslated) address history, | As also shown in this example, each detector entry |
| International Mobile Equipment Identity | object can include: |
| (IMEI) and other device identifier information | an additional internal identifier utilized by |
| method calls in this app.”, | the application scanning service system 104 |
| “developerAction”: “Check off the Device | to identify the detector entry (or group) |
| identifiers identifications below once you | within a scan result (e.g., |
| have confirmed the method calls behave as | “adjustDeviceId”), |
| you designed. These will also be displayed as | an additional external identifier (e.g., |
| reviewed (checked off) on the next analysis.”, | “name: Device identifiers”), description |
| “type”: “Analytics”, | (e.g., “This detection has found . . .), and |
| “targets”: [ | developer action (e.g., “Check off the . . .) |
| { | that the application scanning service system |
| “className”: | 104 can include in the scan report, |
| “com.adjust.sdk.plugin.MacAddressUtil”, | data collection information (e.g., as a data |
| “methodName”: “getMacAddress” | category) to indicate the data type collected |
| }, | by target functionalities (e.g., “type”: |
| { | “APPROX_LOCATION”) in the detector |
| “className”: | entry and/or the purpose type of this data |
| “com.adjust.sdk.plugin.MacAddressUtil”, | collection (e.g., “type: Analytics”), and/or |
| “methodName”: “getRawMacAddress” | one or more target functionalities, such as |
| }, | method names and their class as included in |
| { | the code of an input application (e.g., a |
| “className”: | target functionality having class name |
| “com.adjust.sdk.IActivityHandler”, | “com.adjust.sdk.plugin.MacAddressUtil” |
| “methodName”: “getDeviceInfo” | and method name “getMacAddress”) |
| }, | Indeed, the application scanning service system 104 |
| { | can utilize the identifiers, target functionalities, |
| “className”: | and/or namespaces as signatures to compare with |
| “com.adjust.sdk.MacAddressUtil,”, | function call component signatures identified in an |
| “methodName”: “getMacAddress” | input application code. |
| } | |
| ] | |
| }, | |
| { | |

In reference to Table 2, the application scanning service system 104 can utilize a detector specification to generate (or create) a list of detector specification entries (e.g., “detectorGroups”). Indeed, the application scanning service system 104 can generate a list of detector specification entries for various detector specifications. Additionally, the application scanning service system 104 can utilize one or more detector specification entries to separately detect a module of a data processing activity component (e.g., an SDK component, an API component) from multiple (nested) components that might be included in the data processing activity component. In one or more aspects, the application scanning service system 104 can also utilize the detection specification entry (e.g., a detector group or object) to enable forward compatibility when the detector specification is updated (or modified) to identify additional behaviors, data processing activity components, and/or data categories to detect in an input application. Indeed, the application scanning service system 104 can uniquely identify each detector entry by a detector group identifier and/or a detector identifier (as shown in Tables 1 and 2).

In the examples depicted in Tables 1 and 2, the application scanning service system 104 can declare multiple top-level “namespaces” (within a detector specification entry). In one or more aspects, the application scanning service system 104 can utilize multiple top-level “namespaces” in the detector specification to enable (or account for) modular data processing activity component grouping (e.g., an SDK). As an example, the application scanning service system 104 can utilize, from the data processing activity component library 108, a single detector specification for multiple top-level “namespaces” of the grouped data processing activity component (e.g., SDK) and/or can utilize different detector specifications for different top-level “namespaces” of that grouped data processing activity component (e.g., SDK) (based on an effectiveness in detecting and classifying data processing activity features within an input application).

The examples in Tables 1 and 2 are provided for illustrative purposes. The application scanning service system 104 can utilize, combine, and/or modify the features of these examples (and/or one or more other detector specifications) to implement an application service described herein.

As mentioned above, in one or more aspects, the application scanning service system 104 updates a detector specification. In particular, in one or more cases, the application scanning service system 104 detects and/or receives changes to one or more data processing activity components and/or data processing activity component groups. In some instances, the application scanning service system 104 pulls or retrieves changes to one or more data processing activity components and/or data processing activity component groups via a source, such as, but not limited to, a source code repository and/or a software development version controlling platform. Moreover, the application scanning service system 104 can utilize the detected changes in the one or more data processing activity components and/or data processing activity component groups to update data categories, identifiers, targets, signatures, namespaces, and/or other information for the one or more data processing activity components and/or data processing activity component groups within the detector specification.

In some applications, the application scanning service system 104 can create and/or implement one or more hierarchical categorization schemes via the detector specification for data processing activity components. For instance, the application scanning service system 104 can associate a first categorization level (e.g., a high-level data type such as “LOCATION” or a high-level purpose such as “ANALYTICS) to a first hierarchical level in a detector specification entry (or grouping of detector specification entries). Moreover, the application scanning service system 104 can associate a second, more specific, categorization level (e.g., a more specific sub-type of “LOCATION” such as “APPROX LOCATION” or “ADDRESS”) to a second hierarchical level in a detector specification entry (or a grouping of detector specification entries) for a specific data processing activity component and/or target functionality within the detector specification.

Although some aspects herein describe utilizing a particular data object entries (e.g., JSON entries), the application scanning service system 104 can utilize various types of detector specifications. For instance, the application scanning service system 104 can utilize a matrix-based detector specification that maps between one or more data processing activity component identifiers and descriptive data (e.g., data types, purpose of data processing) for the data processing activity component identifiers. As another example, the application scanning service system 104 can utilize a lookup table-based detector specification that enables queries of function call component signatures to retrieve descriptive data (e.g., data types, purpose of data processing) for one or more data processing activity components corresponding to the function call component signatures.

As an example, the application scanning service system 104 can utilize a detector specification (e.g., to identify one or more data processing activity components) as described in SCANNING APPLICATION CODE TO DETECT AND CLASSIFY SDK DATA INTO DATA CATEGORIES, U.S. patent application Ser. No. 18/490,344, filed Oct. 19, 2023 (hereinafter “application Ser. No. 18/490,344”), which is incorporated herein by reference in its entirety.

Furthermore, FIG. 1 includes a client computing system 106. In one or more aspects, the client computing system 106 includes a system operated (or implemented) on a computing device (or a network of computing devices). Indeed, the computing device of the client computing system 106 can include a variety of types and number of computing devices, including those described with reference to FIG. 11. In some cases, the client computing system 106 includes a developer computing system, a source code management system, and/or a software deployment platform. In addition, the client computing system 106, via the client application 114, can deploy, modify, display, and/or execute one or more application codes and/or one or more applications corresponding to the application codes.

In some cases, the client computing system 106 includes a system operated on a user device operated by a user of an application. In one or more embodiments, the client computing system 106, via the client application 114, can execute an application from the input application code 118 in the client repository 116. Furthermore, within the application scanning service system 104 environment, the user device-based client application 114 can communicate with the server system 102 to scan the input application code 118 in accordance with some aspects herein.

As shown in FIG. 1, the client computing system 106 includes a client repository 116. In one or more instances, as shown in FIG. 1, the client computing system 106 stores one or more application codes as input application code 118 within the client repository 116. Indeed, the client repository 116 can include one or more application codes for one or more applications and/or data processing activity components (e.g., an SDK, API, code library).

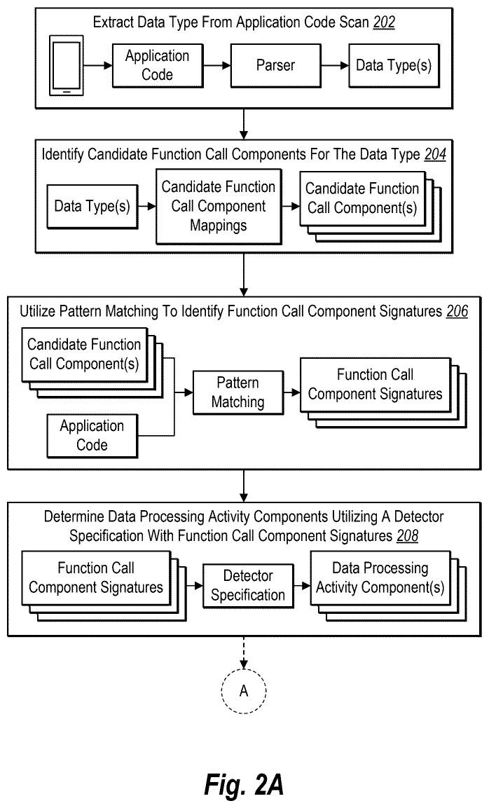

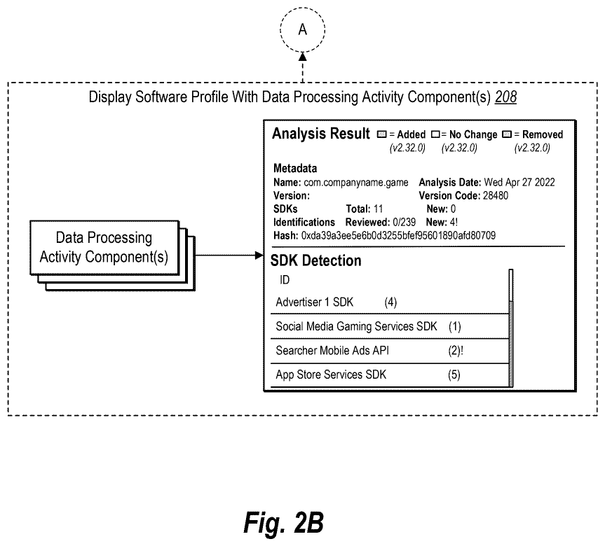

Indeed, in the example illustrated in FIG. 1, the server system 102, via the application scanning service system 104, can execute an application scanning service that can access a data processing activity component library 108. The server system 102 can access input application code 118, which can be uploaded or otherwise provided to the application scanning service system 104 via the client application 114 executed on the client computing system 106 (as described above). Moreover, the application scanning service system 104 can scan the input application code 118 and determine data processing activity component(s) for the input application code 118 (when executed) as described herein (e.g., in reference to FIGS. 2-9).

In some aspects, a client computing system 106 requests an application scan of an application code by the application scanning service system 104. For instance, the client computing system 106 can transmit an application code scan request to the application scanning service system 104 (via the server system 102). In addition, in some cases, the client computing system 106 can also upload the input application code 118 to the server system 102 with the scan request. Indeed, the application scanning service system 104 can scan the uploaded input application code 118 (in response to the received scan request) to determine one or more data processing activity components in the application code in accordance with one or more aspects herein. In addition, the server system 102 can provide the one or more data processing activity components (or a software profile for the application code having scan results) to the client computing system 106 (e.g., for display on a client device of the client computing system 106).

Furthermore, in some cases, the client computing system 106 can implement the application scanning service system 104. For instance, the client computing system 106 can receive and deploy the application scanning service system 104 within the client computing system 106. Subsequently, the client computing system 106 can utilize the application scanning service system 104 (in accordance with one or more aspects herein) natively on the client computing system 106.

To illustrate an example of the application scanning service system 104 performing a scan of an input application in the environment illustrated in FIG. 1, the application scanning service system 104 can extract data types from the input application code 118 (using a code parser) and determine candidate function call components for the data types (e.g., using candidate function call component mappings). Furthermore, the application scanning service system 104 can utilize the candidate function call components to match with function call component signatures within the input application code 118 (e.g., to determine the function call component signatures). Additionally, the application scanning service system 104 can determine a particular detector specification entry and/or a detector specification entry group to which the function call component signatures belong (or match to) from the one or more detector specification(s) 110 (in the data processing activity component library 108). Indeed, the application scanning service system 104 can utilize the determined particular detector specification entry and/or a detector specification entry group to determine and display data processing activity components corresponding to the input application code 118 (e.g., within a scan report and/or software profile with a scan report).

Moreover, although FIG. 1 illustrates the environment with a single server system 102 and a single client computing system 106, in one or more aspects, the application scanning service system 104 can interact with additional computing systems (or various numbers of computing devices within the computing systems). For example, the application scanning service system 104 can interact with a variety of different numbers of computing systems corresponding to one or more application users and/or administrators (or developers) of applications. Additionally, although FIG. 1 illustrates the application scanning service system 104 interacting with a single client repository 116 and a single data processing activity component library 108, the application scanning service system 104 can interact with a variety of different numbers of data processing activity component libraries, detector specification repositories, and/or client application code repositories.

Moreover, as shown in FIG. 1, the application scanning service system 104 can utilize a network 111 to enable communication between the server system 102 and the client computing system 106. In some instances, the network 111 can include a suitable network and may communicate using any communication platform and technology suitable for transporting data and/or communication signals, examples of which are described with reference to FIG. 11. Moreover, the various components of the server system 102 and the client computing system 106 can communicate and/or interact via other methods (e.g., the application scanning service system 104 or the server system 102 and the client repository 116 can communicate directly).

As mentioned above, the application scanning service system 104 can scan application codes to intelligently detect data processing activity components utilized a type-based analysis. For instance, FIGS. 2A-2B illustrates an overview of the application scanning service system 104 scanning an application code utilizing a data type-based analysis to determine data processing activity components present in the application code. More specifically, FIGS. 2A-2B illustrates the application scanning service system 104 extracting data types from an application code scan, identifying candidate function call components from the data types, utilizing pattern matching to identify function call component signatures (from the candidate function call components), determining data processing activity components utilizing a detector specification with the function call component signatures, and (in some cases) displaying a software profile (as a scan report) with the determined data processing activity components for the application code.

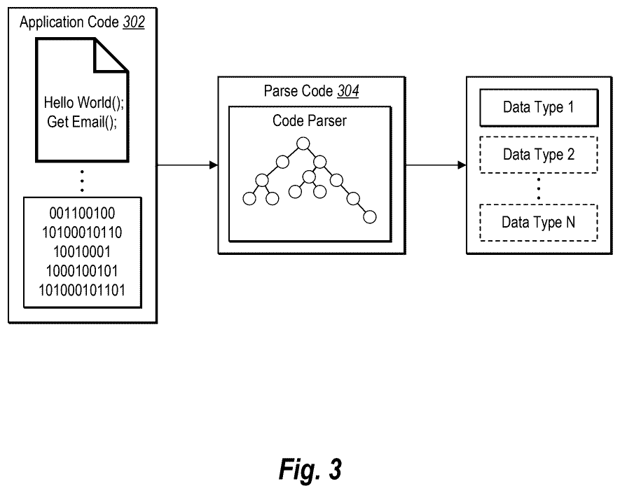

As shown in act 202 of FIG. 2A, the application scanning service system 104 extracts a data type from an application code scan. Specifically, as shown in the act 202, the application scanning service system 104 can utilize a parser to scan (or parse) an application code to identify one or more data types (e.g., type information) indicated or used in the input application score. Indeed, the application scanning service system 104 can extract data types from an application code as described herein (e.g., in reference to FIGS. 1 and 3).

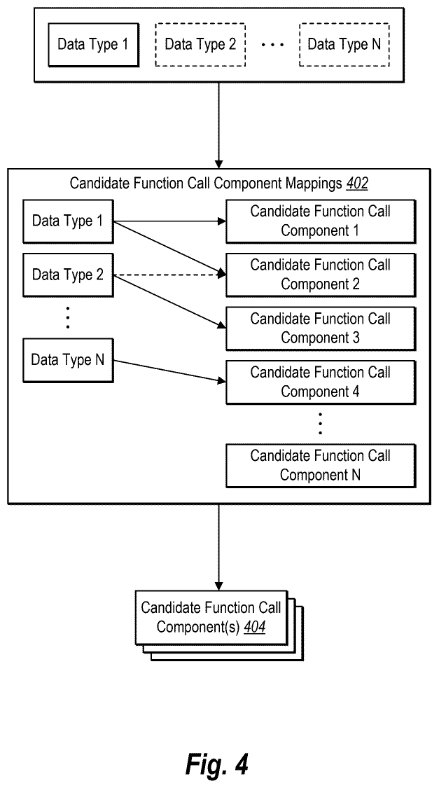

Furthermore, as shown in act 204 of FIG. 2A, the application scanning service system 104 identifies candidate function call components for the data type. In particular, the application scanning service system 104 can utilize candidate function call component mappings that map data types to various candidate function call components to identify the candidate function call components. For instance, the application scanning service system 104 can select candidate function call components that map to the particular data type from the candidate function call component and data type mappings. Indeed, the application scanning service system 104 can identify candidate function call components based on extracted data types as described herein (e.g., in reference to FIG. 4).

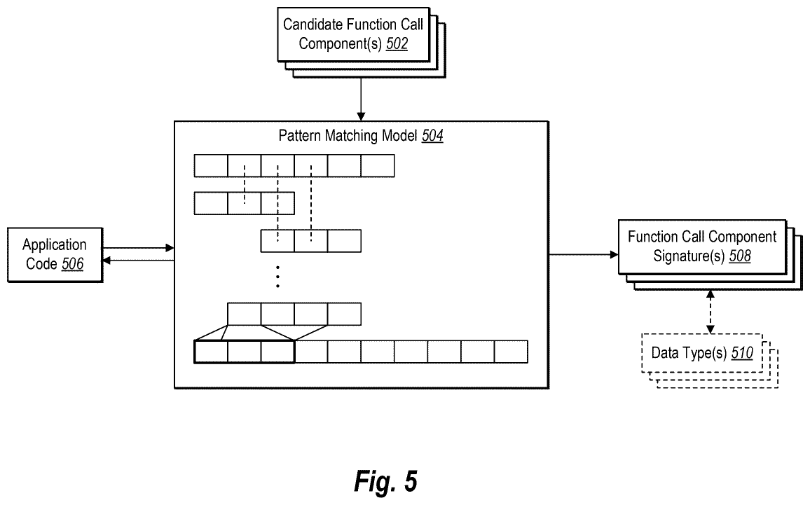

Moreover, as shown in act 206 of FIG. 2A, the application scanning service system 104 utilizes pattern matching to identify function call component signatures (from an application code). In particular, as shown in FIG. 2A, the application scanning service system 104 can utilize candidate function call component(s) and the application code with a pattern matching model to identify function call component signatures (e.g., method signatures, reference signatures, target signatures) within the application code that are similar to the candidate function call component(s). Indeed, the application scanning service system 104 can utilize pattern matching to identify one or more function call component signatures as described herein (e.g., in reference to FIG. 5).

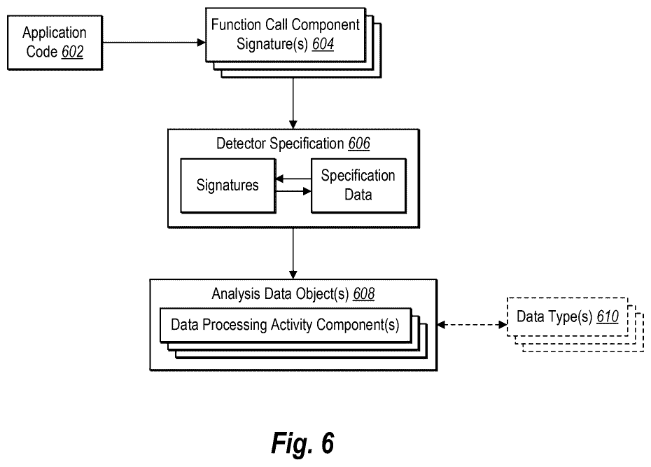

Furthermore, as shown in act 208 of FIG. 2A, the application scanning service system 104 determines data processing activity components utilizing a detector specification with function call component signatures. For instance, as shown in FIG. 2A, the application scanning service system 104 can utilize the function call component signatures identified from the application code with a detector specification (as described above) to identify one or more detector specification entries that include the function call component signatures (e.g., as identifiers, as namespaces, as targets). Moreover, the application scanning service system 104 can determine data processing activity components that correspond to the identified one or more detector specification entries as data processing activity components for the application code. Indeed, the application scanning service system 104 can determine data processing activity components for an application code as described herein (e.g., in reference to FIG. 6).

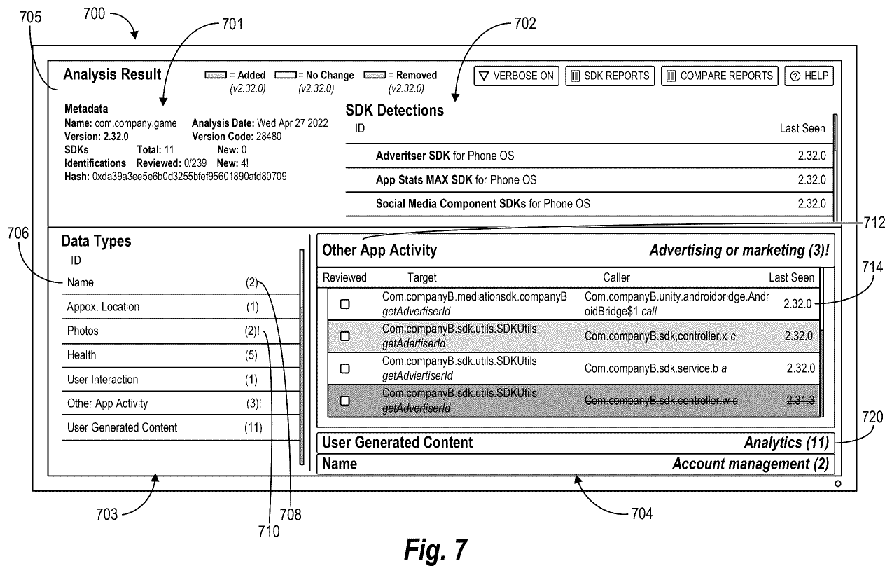

In some cases, as shown in act 210 of FIG. 2B, the application scanning service system 104 displays a software profile with data processing activity component(s) (e.g., as a scan report) for an application code. As shown in FIG. 2B, the application scanning service system 104 can display particular data processing activity components present in the application code and various other scanned data for the application code as a software profile. Indeed, the application scanning service system 104 can display a variety of scan results within a software profile to indicate data processing activity components, version history of added and/or removed data processing activity components, data categories (or types) of data processing activity components corresponding to a scanned application code as described herein (e.g., in reference to FIGS. 7-9).

As mentioned above, the application scanning service system 104 can extract a data type from an application code scan. For instance, FIG. 3 illustrates the application scanning service system 104, in response to an application code scan, extracting one or more data types from an application code. Indeed, as shown in FIG. 3, the application scanning service system 104 utilizes a code parser (in an act 304) to parse code of an application code 302. As further shown in FIG. 3, the application scanning service system 104 parses code (in the act 304) of the application code 302 to extract data type(s) present (or detected) in the parsed application code (e.g., data type 1-N). Furthermore, as shown in FIG. 3, the application scanning service system 104 can parse the application code 302 to identify (or determine) various numbers of data types (e.g., various combinations of data types 1-N).

In one or more instances, the application scanning service system 104 utilizes a code parser that parses application code (e.g., source code) to identify data from the application code. In some cases, the application scanning service system 104 can utilize a code parser to read the application code. For example, the application scanning service system 104 can parse assembly language or other source code language of the application code. In one or more aspects, the application scanning service system 104 utilizes a code parser to determine (or identify) components of the application code, such as, keywords, signatures, identifiers, operators, syntax, and/or other data structures within the application code.

In some cases, the application scanning service system 104 can utilize a code parser to tokenize an application code into components, such as, keywords, signatures, identifiers, operators, syntax, and/or other data structures within the application code. In some cases, the application scanning service system 104 can utilize a code parser to generate a call graph from an application code (or the tokens generated from the application code) that includes a structure of the application code with tiered nodes that indicate and/or represent one or more components within the application code. For instance, the application scanning service system 104 can generate, as a call graph, a syntax tree (e.g., an abstract syntax tree) that represents a hierarchical structure of the application code with nodes representing code language components, such as, but not limited to, expressions, statements, functions, classes, data types, and/or references. In some cases, the application scanning service system 104 generates a call graph as described in application Ser. No. 18/490,344.

In one or more aspects, the application scanning service system 104 utilizes a code parser, such as, but not limited to, a top-down parser (e.g., an LL parser), a look-ahead, left-to-right, rightmost derivation parser (LALR) parser, and/or a DEX file format parser. Indeed, in some cases, the code parser generates a parser file or structure to represent the components of the application code in a readable format, such as, but not limited to, a DEX file, a lexer code file, and/or tree representation (e.g., an abstract syntax tree).

Furthermore, in one or more aspects, the application scanning service system 104 utilizes a parser output (e.g., a parser file or structure) representing components of an application code to extract data types from an application code. For instance, the application scanning service system 104 can traverse or search a parser output of an application code to identify data types corresponding to the expressions, statements, functions, classes, data types, and/or references of an application code (in a parser output file or structure). Indeed, the application scanning service system 104 can search the parser output to detect the presence of one or more data types. In some aspects, the application scanning service system 104 utilizes a reference or list of known data types to search in the parser output of the application code to detect the presence of one or more data types in the application code.

For example, the application scanning service system 104 can detect the presence of a variety of data types from an application code. To illustrate, the application scanning service system 104 can detect data types for various numerical data, string data, sensor data, file data, and/or device data. Furthermore, the application scanning service system 104 can detect various categories of data types, such as, but not limited to personal identifiable information (or other personal data), financial data, location data, search and browsing data, email and text data, media (e.g., photo and video) data, audio data, health and/or fitness data, contact information data, calendar data, app performance data, file and document data, application activity data, and/or device data. In some aspects, the application scanning service system 104 can identify data types, such as, but not limited to, names, email addresses, user account identifiers, addresses, phone numbers, gender, birthdate, age, purchase history data, credit score data, bank account information data, approximate location data, precise location data, email data, photos data, audio data, music data, biometrics data, crash log data, file data, search history data, cookies data, and/or device identifier data.

In some instances, the application scanning service system 104 can identify data types from a defined list of data types. For instance, the application scanning service system 104 can extract or identify data types corresponding to a third-party list of data types or a user defined list of data types (e.g., a list of sensitive data types, a list of highly-sensitive data types). For example, in one or more aspects, the application scanning service system 104 can target particular data types from a list of data types. To illustrate, as an example, the application scanning service system 104 can utilize a list of data types having the data types of name, email, user account, address, phone, race and/or ethnicity, political affiliation, religious affiliation, gender and/or sexual orientation, other personal information, purchase history, credit score, bank account number, other financial information, approximate location, precise location, web history, emails, SMS logs, other messages, photos, videos, audio, music, other audio, health, fitness, contacts, calendar, crash logs, performance diagnostics, other performance data, files and document data, user interaction, in app search history, applications on device information, user generated content, other application activity, and device identifiers.

As mentioned above, the application scanning service system 104 can identify one or more candidate function call components for a data type. For instance, FIG. 4 illustrates the application scanning service system 104 identifying one or more candidate function call components. As shown in FIG. 4, the application scanning service system 104 utilizes extracted data types (e.g., data types 1-N) from an application code with candidate function call component mappings 402 to select one or more candidate function call components 404 (in response to the extracted data types). As an example, in reference to FIG. 4, the application scanning service system 104 can utilize a data type 1 extracted from an application code to identify mappings to candidate function call component 1 and candidate function call component 2 in the candidate function call component mappings 402 (e.g., as the candidate function call component(s) 404).

In some aspects, the application scanning service system 104 utilizes a candidate function call component mapping that creates mappings (or associations) between data types and one or more candidate function call components. Indeed, the application scanning service system 104 can utilize a mapping between data types and one or more candidate function call components represented as potential target names, potential code references, and/or potential method signatures that are utilized in application codes to process the particular data types. In addition, the application scanning service system 104 can utilize an extracted data type to search the candidate function call component mapping to identify one or more candidate function call components associated with (or corresponding to) the data type.

In some instances, the function call component mapping can include data types that map to multiple candidate function call components. Additionally, in some aspects, the function call component mapping can include candidate function call components that map to multiple data types. Indeed, an application scanning service system 104 can utilizes (or generate) a function call component mapping represented through structures, such as, but not limited to, a matrix, a data spreadsheet (e.g., a spreadsheet indicating data types, corresponding candidate function call components, data type categories), and/or a data tree (e.g., with data type nodes and candidate function call component sub-nodes).

As an example, in some cases, the application scanning service system 104 can utilize a function call component mapping that includes mappings between data type names and potential candidate function call components (as target method names), such as, but not limited to, “getFirstName,” “getLastName,” and/or “getName.” For example, the application scanning service system 104 can extract, from an application code, a data type of approximate location. Then, in one or more aspects, the application scanning service system 104 can determine, from a function call component mapping, potential candidate function call components (as target method names), such as, but not limited to, “getGeoLocation,” “getGPS,” “getLatitude,” and/or “getLongitude” that map to a data type name of “location.”

Moreover, as another example, the application scanning service system 104 can extract, from an application code, a data type of photos. Furthermore, the application scanning service system 104 can access a function call component mapping for a data type name of “photos” to identify candidate function call components that maps to data type name of “photos” (as target method names), such as, but not limited to, “getPhotos,” “getPhotoURL,” and/or “getPhotoMetadata.” Although one or more candidate function call components are described above, the application scanning service system 104 can utilize (or generate) a mapping between various data types and various candidate function call components.

In some aspects, the application scanning service system 104 generates candidate function call components for a data types (for the candidate function call component mappings). As an example, the application scanning service system 104 can generate one or more potential target method names and/or references (as function call components) for a particular data type. Indeed, in some cases, the application scanning service system 104 can utilize a machine learning model (or generative machine learning model) to generate potential target method names and/or references (as function call components) for a particular data type. To illustrate, the application scanning service system 104 can utilize a data type (or a string describing the data type) with a generative model to generate potential target method names and/or references utilized for the data type. For example, the application scanning service system 104 can utilize a generative model, such as, but not limited to, a large language model, a generative pre-trained transformer model, a neural network, and/or a generative adversarial neural network.

In some instances, the application scanning service system 104 can also utilize a web scraper to identify one or more potential target method names and/or references utilized for a particular data type (e.g., using a search of the particular data type). As an example, the application scanning service system 104 can utilize a natural language processing (NLP) web scraper that targets SDK developer documents and/or programming file repositories (e.g., open source GIT repositories) available via websites and/or public (or accessible private) networks. Moreover, in one or more instances, the application scanning service system 104 can receive user input for potential target method names and/or references in association with a particular data type to generate mappings in the function call component mapping.

As mentioned above, the application scanning service system 104 can utilize pattern matching to identify function call component signatures (from an application code). For instance, FIG. 5 illustrates the application scanning service system 104 identifying function call component signatures from an application code utilizing candidate function call components 502. As shown in FIG. 5, the application scanning service system 104 utilizes a pattern matching model 504 with an application code 506 to match candidate function call component(s) 502 (selected based on the extracted data types) to components (or component signatures) within the application code 506. Indeed, upon identifying one or more component signatures similar to the candidate function call component(s) 502, the application scanning service system 104 can utilize the matching component signatures as function call component signature(s) 508. In addition, in some cases, the application scanning service system 104 can also identify data type(s) 510 corresponding to the function call component signature(s) 508 (from the application code).

In one or more aspects, the application scanning service system 104 utilizes a pattern matching model to identify patterns (e.g., through sequences of tokens or structures) in an application code that matches an input sequence (or data). For instance, in some aspects, the application scanning service system 104 utilizes a pattern matching model to identify patterns as function call component signatures (e.g., method name signatures, reference call signatures) that match (or are similar) to one or more candidate function call components (e.g., potential method names, potential reference names). Indeed, the application scanning service system 104 can utilize a pattern matching model to search for specific code in an application code codebase to identify instances (or components) that resemble (or are similar to) an input candidate function call component.

In one or more aspects, the application scanning service system 104 utilizes pattern matching models that use string pattern matching (e.g., through regular expressions). Indeed, the application scanning service system 104 can utilize a pattern matching model to identify a match between sequences (e.g., token sequences) of strings to other sequences (e.g., a string sequence of the candidate function call component and a string sequence within an application code representing a component). In one or more instances, the application scanning service system 104 can utilize regular expressions with backtracking to match candidate function call components to components (or component signatures) within the application code.

In some cases, the application scanning service system 104 utilizes a pattern matching model that determines distances between candidate function call components and function call component signatures (or components) in an application code. For instance, the application scanning service system 104 can utilize a pattern matching model to generate feature representations for the between candidate function call components and function call component signatures (or components) in a feature space to determine distances between the feature representations for similarity determinations (e.g., using Euclidean distances, cosine similarity). In some cases, the application scanning service system 104 utilizes a pattern matching model that utilizes clustering algorithms to determine similarities between the candidate function call components and function call component signatures (or components).

For example, the application scanning service system 104 can identify function call component signatures from an application code (or parser output of the application code as described above) that match with the one or more candidate function call components (determined using the extracted data types). In some aspects, the application scanning service system 104 identifies function call component signatures from the application code that a pattern matching model indicates as similar to one or more of the input candidate function call components.

As an example, the application scanning service system 104 can utilize a pattern matching model to search an application code for function call component signatures similar to candidate function call components of “getName,” “getFirstName,” and “getLastName.” In response, the application scanning service system 104 can identify, through the pattern matching model, function call component signatures from the application code as method signatures, such as “getName,” “getFullName,” and/or “getMiddleName.” As another example, the application scanning service system 104 can utilize a pattern matching model to search an application code for function call component signatures similar to candidate function call components of “getPhoto” and “getPhotosURL.” In response, the application scanning service system 104 can identify, through the pattern matching model, function call component signatures from the application code as method signatures, such as “getImage,” “getImageFile,” and/or “getPhoto.” Indeed, the application scanning service system 104 can identify identical and/or similar function call component signatures based on the candidate function call components utilizing a pattern matching model.

In some instances, upon identifying one or more function call component signatures from an application code (using pattern matching models as described above), the application scanning service system 104 can also identify data types in the application code (or a parser output of the application code) that correspond to the one or more function call component signatures. For example, the application scanning service system 104 can identify, within a parsed structure of the code (e.g., a call graph or parser DEX file), one or more data types associated with the matched function call component signatures. Indeed, the application scanning service system 104 can tag (or associate) the data types to the function call component signatures to generate data categories within a scan report for the application scan (e.g., as shown in FIGS. 7-9).

As mentioned above, the application scanning service system 104 can determine data processing activity components utilizing a detector specification with one or more function call component signatures. For instance, FIG. 6 illustrates the application scanning service system 104 determining data processing activity components based on the identified one or more function call component signatures. Indeed, as shown in FIG. 6, the application scanning service system 104 utilizes function call component signature(s) 604 (identified in accordance with one or more implementations herein) from the application code 602 with a detector specification 606. In particular, as shown in FIG. 6, the application scanning service system 104 utilizes the signatures (from the function call component signature(s) 604) to identify matching signatures within specification data (of the detector specification 606). Moreover, as shown in FIG. 6, the application scanning service system 104 utilizes the identified specification data of the detector specification 606 to determine analysis data object(s) 608 (having one or more data processing activity component(s)). Additionally, in some cases, the application scanning service system 104 can also identify data type(s) 610 corresponding to the data processing activity component(s) of the analysis data object(s) 608.

In one or more aspects, the application scanning service system 104 searches one or more detector specifications to identify a signature that matches a function call component signature identified from the application code (in accordance with one or more implementations herein). For example, the application scanning service system 104 can search the one or more detector specifications to match (e.g., a pattern match as described above) a function call component signature to a signature (e.g., a target name, identifier, namespace) in the one or more detector specifications. Based on identifying a signature in the one or more detector specifications, the application scanning service system 104 can identify a detector specification entry corresponding to the identified signature. Furthermore, the application scanning service system 104 can identify one or more data processing activity components corresponding to the detector specification entry. Indeed, the application scanning service system 104 can determine that the identified one or more data processing activity components are present in the application code based on the signature match with the function call component signature identified from the application code.

In some cases, the application scanning service system 104 can generate an analysis data object for the one or more data processing activity components using the identified detector specification entry. For instance, the application scanning service system 104 can generate an analysis data object that indicates a detected data processing activity component and various descriptive data (e.g., identifiers, sub-components, components, data categories, code locations, and/or modifications) from the detected data processing activity component. As an example, the application scanning service system 104 can generate an analysis data object that includes an appID field that can include a unique identifier by which the application scanning service system 104 references an input application (e.g., a record number), an appName field that can indicate a name for the input application (e.g., a program name provided by a developer or other user of the application scanning service system 104), an app Version field that can identify which version of an input application was used to generate the set of scan results, and an appVersionCode field derived from the appVersion field. In addition, the analysis data object can include instances of certain data processing activity components (e.g., features) detected in the input application code and descriptive data for the data processing activity components. For example, the application scanning service system 104 can generate (or utilize) analysis data objects as described in application Ser. No. 18/490,344.

Indeed, as mentioned above, the application scanning service system 104 can determine data processing activity components (from the detector specification based on the signature matches) that indicate specific components present in the application code. For instance, the data processing activity components can include software development kit (SDK) components, mobile SDKs, application programming interface (API) components, website cookies, website functions, or function call component within an application code (that enables processing, collecting, accessing, storing, retrieving, modifying, or deleting data). Indeed, the application scanning service system 104 can identify data processing activity components as described in application Ser. No. 18/490,344.

In some instances, the application scanning service system 104 can also identify data types that correspond to the one or more data processing activity components (from the detector specification). For example, the application scanning service system 104 can identify, within the detector specification entries for the one or more data processing activity components, one or more associated data types. In some cases, the application scanning service system 104 can utilize the data types tagged (or associated) with the function call component signatures (used to search the detector specifications) as the associated data types for the one or more determined data processing activity components. Indeed, the application scanning service system 104 can utilize the data types to display data categories (or types) within a scan report for the application scan (e.g., as shown in FIGS. 7-9).

In some instances, the application scanning service system 104 can utilize the identified function call component signatures to search within web-based detector specifications. For instance, in some cases, the application scanning service system 104 can search a web-based (or client computer storage) library of SDKs to identify matching signatures for the identified function call component signatures. Based on the search, the application scanning service system 104 can identify one or more entries in the library of SDKs to identify data processing activity components present in the application code (e.g., SDK functions, SDK references) based on the function call component signatures.

Furthermore, the application scanning service system 104 can also update one or more detector specifications. For example, the application scanning service system 104 can receive an update to a detector specification to add, modify, or remove one or more detector specification entries. Indeed, the updates to the detector specification can indicate an addition, modification, and/or removal of one or more data processing activity components and/or data corresponding to the data processing activity components (e.g., data types, data processing activity descriptions, identifiers, data processing purposes). In one or more aspects, the application scanning service system 104 can utilize updated detector specifications in one or more application code scans (e.g., via function call component signature matching as describe above) to update data processing activity components corresponding to an application code (e.g., in an updated scan and/or a subsequent scan of the same or updated version of the application code).

In some cases, the application scanning service system 104 can identify data processing activity component modifications from different versions of an application code. For example, as used herein, the term “data processing activity component modification” refers to a change corresponding to a particular data processing activity component (between versions of an application code and/or due to an update from the data processing activity component source). In particular, a data processing activity component modification can include a change in content, data type, and/or functionality of a data processing activity component. In addition, a data processing activity component modification can include an addition and/or removal of a data processing activity component from an application code. In one or more aspects, the data processing activity component modification can result from a modification of an application code in between versions of the application code. In some aspects, a data processing activity component modification can include a change in a definition, functionality, and/or data type associated with a data processing activity component based on changes to the component via a developer and/or source of the data processing activity component modification (e.g., an update in an SDK library, API, and/or function call).

For example, the application scanning service system 104 can compare analysis data object(s) between the application code scans of the application code versions. Indeed, the application scanning service system 104 can compare the analysis data object(s) to identify changes in the data processing activity components (e.g., an addition and/or removal of a data processing activity component) as data processing activity component modification(s). Moreover, the application scanning service system 104 can flag the changes in the data processing activity components between the application code versions (i.e., between the analysis data object(s) of the prior version of the application code and a current version of the application code). In addition, the application scanning service system 104 can determine (or track) a total number of added and/or removed data processing activity components between the application code versions. Indeed, the application scanning service system 104 can identify data processing activity component modification(s) as described in application Ser. No. 18/490,344.

In some cases, the application scanning service system 104 can identify, from one or more detector specifications, a vulnerability flag for a data processing activity component. For instance, the application scanning service system 104 can identify a vulnerability flag that indicates a security flaw and/or a technical flaw corresponding to a data processing activity component. As an example, the vulnerability flag can include security flag indications, such as, but not limited to, data information leaks, unencrypted transmittal of data, viruses, malware, and/or malignant actors corresponding to a data processing activity component. Furthermore, as another example, the vulnerability flag can include technical flaw indications, such as, but not limited to, bugs, SDK crashes, unreachable networks, errors, memory leaks, and/or out-of-memory issues corresponding to a data processing activity component. In some instances, the detector specification includes one or more vulnerability flags for a data processing activity component with a vulnerability description that describes the security and/or technical flaw corresponding to the data processing activity component.

Indeed, upon identifying a data processing activity component for the application code (in accordance with one or more implementations herein), the application scanning service system 104 can also determine one or more vulnerability flags corresponding to the data processing activity component. In some instances, the application scanning service system 104 displays a software profile (e.g., with a scan report) to indicate the data processing activity components corresponding to the scanned application code with one or more associated vulnerability flags. Indeed, the application scanning service system 104 can display a graphical user interface with a scan report to indicate one or more data processing activity components with one or more associated vulnerability flags in accordance with the graphical user interfaces described below (e.g., in reference to FIGS. 7-9).

In some cases, the application scanning service system 104 can further identify a dependency file for a data processing activity component. In particular, the application scanning service system 104 can identify a dependency file corresponding to a data processing activity component (e.g., within a detector specification) that indicates one or more dependencies (e.g., dependent libraries, references, SDKs) corresponding to a particular data processing activity component. In some cases, the application scanning service system 104 can include or display the dependencies (or dependency file) with the scan report for the application code.

As mentioned above, in some aspects, the application scanning service system 104 displays a software profile with data processing activity component(s) (e.g., as a scan report) for an application code. For instances, FIGS. 7-9 illustrate the application scanning service system 104 displaying a variety of scan results within a software profile to indicate data processing activity components, version history of added and/or removed data processing activity components, data categories (or types) of data processing activity components corresponding to a scanned application code.

For example, FIG. 7 illustrates the application scanning service system 104 generating, for display within a client or computing device, a graphical user interface to display dynamic scan results from an application scan of an input application (or application code). For instance, the application scanning service system 104 generates, for display within a computing device 700, a graphical user interface 705 that includes a metadata section 701, an SDK detection section 702, a data type section 703, and a target detections section 704 for a scan of an input application (or application code).

As shown in FIG. 7, the application scanning service system 104 generates a graphical user interface with a metadata section 701 that displays information about a scan result and the scanned application. Furthermore, as shown in FIG. 7, the metadata section 701 also displays information about the total number of SDKs (e.g., groupings of data processing activity components) detected (or utilized) by the selected version of the input application and the number of “new” SDKs detected (or utilized) by the selected version of the input application.

As further shown in FIG. 7, the application scanning service system 104 generates, for display within the graphical user interface 705, the SDK detection section 702. As illustrated in FIG. 7, the application scanning service system 104 displays, within the SDK detection section 702, a list of SDKs (e.g., groupings of data processing activity components) detected across different versions of the input application. For example, the application scanning service system 104 can display various SDKs to indicate various packages (or groups) of data processing components organized by a source SDK (or developer).

Furthermore, the application scanning service system 104 can provide, for display within the graphical user interface 705, a data type section 703 that displays a list of data types detected for the selected version of the input application. For example, the application scanning service system 104 can populate the data type section 703 by determining and displaying a set of data types extracted from the application code (as described above). For example, as shown in FIG. 7, the application scanning service system 104 displays, as a data type 706, an indication that the application code includes a data type of “name.” Furthermore, as shown in FIG. 7, the application scanning service system 104 displays a count 708 of a number of data objects detected for the data type 706.

In one or more cases, the application scanning service system 104 generates the data types displayed in the data types section 703 as selectable interface elements. Upon selection (e.g., user selection) of a data type within the data type section 703, the application scanning service system 104 can display one or more data processing activity components from the application code (for the selected data type) in the target detections section 704.

As further shown in FIG. 7, the application scanning service system 104 can provide, for display within the graphical user interface 705, indicators to represent changes in components for one or more data types in the data types section 703. As illustrated in FIG. 7, the application scanning service system 104 displays an indicator 710 to indicate a change in a number of data processing activity components detected in an application code for a particular data type (e.g., media data). Indeed, the application scanning service system 104 can display various indicators for the data types to indicate changes in data types and/or an addition of new data type detected within a version of the application code.

In some cases, the application scanning service system 104 populates the data type section 703 by detecting (and organizing) data types indicated in an analysis data object and/or through the code parser (as described above).

Furthermore, as shown in FIG. 7, the application scanning service system 104 provides, for display within the graphical user interface 705, a target detections section 704. In particular, as illustrated in FIG. 7, the application scanning service system 104 displays, within the target detections section 704, a hierarchical list of data types and target functionalities from the current scan result. For instance, as shown in FIG. 7, the application scanning service system 104 can display, within the target detections section 704, a data type 712 (e.g., a data type of “other app activity”) detected in the application code and the target functionalities 714 (e.g., data processing activity components) that are present in the application code that fall under the data type 712.

As further shown in FIG. 7, the application scanning service system 104 can display closed hierarchical data type (e.g., data type 720) and, upon receiving a user interaction with the closed hierarchical data types, can expand the closed hierarchical data types to display one or more data processing activity components for the closed hierarchical data types.

In one or more aspects, the target detections section 704 identifies, for each target functionality, a caller class/method. For example, the application scanning service system 104 can intelligently determine and dynamically display the data types and target functionalities detected in an application scan to provide improved insight (or an improved useful explanation) of how the input application collects data for certain data types or for certain purposes (even when the application may have thousands or millions of lines of code).

In some cases, the application scanning service system 104 can enable one or more systems to utilize the detection of data types and/or the generated dynamic graphical user interface for modifying the operation of an input application if, for example, unexpected target functionality or data type processing is detected by the application scanning service. For instance, a software development tool operated by a user can be used to modify code of the input application based on a scan result. In some implementations, the application scanning service system 104 enables an application deployment platform system to scan and review an application for unexpected target functionality or data type processing prior to deploying the application. Additionally, the application scanning service system 104 can also enable an application deployment platform system to display the detected data types as information within an application store to notify users of the target functionality or data type processing in an application prior to installing an application.

In one or more instances, the application scanning service system 104 can generate graphical user interface elements that provide data visualizations for the application scan results, such as a chart and/or graph that includes data processing activity components and/or data types detected in an application scan (as described herein). In some cases, the application scanning service system 104 can also, via the graph and/or chart, indicate one or more classes and/or methods that correspond to the SDK(s) and/or one or more data types associated with the SDK (e.g., highly sensitive data types, sensitive data types, non-sensitive data types).

In some aspects, the application scanning service system 104 can generate the user interface 705 utilizing data objects that store, for each scan result, lists of unique SDK namespaces, unique target functionalities, and/or unique data categories. In an illustrative example, the application scanning service system 104 can generate a scan result as JSON object. For instance, the application scanning service system 104 can create an SDK array by parsing the JSON object and adding an element to the array for each newly encountered SDK namespace in the JSON object. Indeed, in one or more instances, the application scanning service system 104 generates a single array element identifying an SDK namespace for multiple occurrences of a given SDK namespace. Furthermore, the application scanning service system 104 can create a target array by parsing the JSON object and adding an element to the array for each newly encountered target functionality in the JSON object. Additionally, in some instances, the application scanning service system 104 can generate, as a scan result, an exportable data type report which summarizes one or more data processing activity components (e.g., SDKs) and one or more associated data categories within an exportable spreadsheet (or other data table) file.

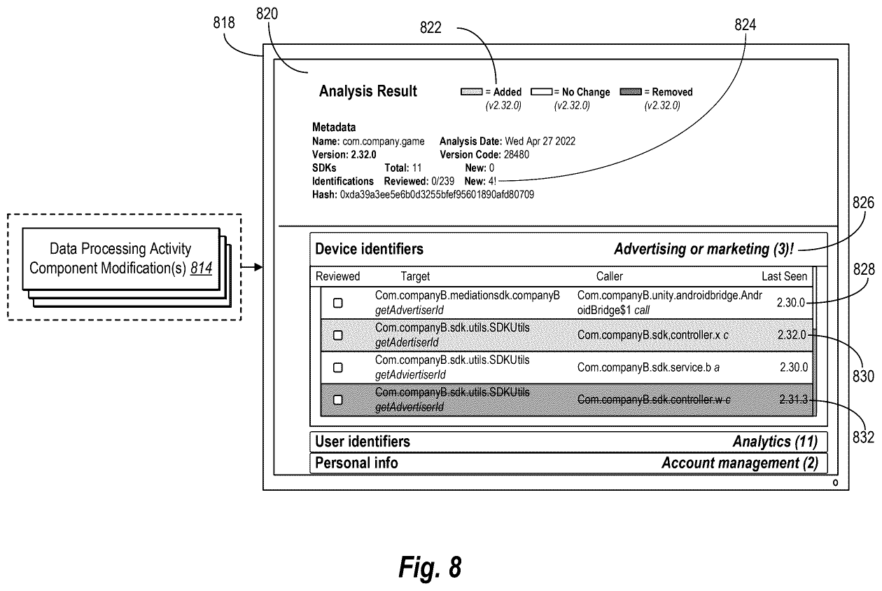

As mentioned above, the application scanning service system 104 can determine changes of data processing activity components detected between scans of different versions of the application code. For example, FIG. 8 illustrates the application scanning service system 104 providing, for display within a graphical user interface, a scan report for an application code that indicates changes of data processing activity components (and/or data types) detected between application code versions.

Furthermore, the application scanning service system 104 can utilize data processing activity component modification(s) to display a scan report for an application code that indicates changes of data processing activity components. For instance, as illustrated in FIG. 8, the application scanning service system 104 utilizes the data processing activity component modification(s) 814 to generate one or more user interface elements for display within, a graphical user interface 820 (e.g., a scan report as described in FIG. 7) on a computing device 818. As shown in FIG. 8, the application scanning service system 104 provides, for display within the graphical user interface 820, a scan report (in accordance with some aspects herein) that indicates metadata (e.g., a name, version, scan date) for an application code scanned by the application scanning service system 104.

Moreover, the application scanning service system 104 can utilize the determined data processing activity component modification(s) 814 to determine a total number of changes. Additionally, as shown in FIG. 8, the application scanning service system 104 displays a counter element 824 to display a number of changes from the data processing activity component modification(s) 814. For example, as shown in FIG. 8, the application scanning service system 104 displays the counter element 824 to indicate the total number of added data processing activity components in the scanned version of the application code in comparison to previous versions. Furthermore, as shown in FIG. 8, the application scanning service system 104 displays a data category indicator 826 with a change indicator to represent a change in a number of data processing activity components in a particular data category. In some cases, the application scanning service system 104 can also display changes in a number of data types extracted from an application code. In some cases, the application scanning service system 104 can also display a number of removed data processing activity components and/or data categories (or types) based on the determined data processing activity component modification(s) 814.

As further shown in FIG. 8, the application scanning service system 104 displays a legend 822 to present a key or mapping for various types of changes detected between application code scans of multiple versions of an application code. For instance, as shown in the legend 822 the application scanning service system 104 can utilize graphical color elements to indicate added data processing activity components, removed data processing activity components, and data processing activity components with no change.

Indeed, as shown in FIG. 8, the application scanning service system 104 can apply visual indicators to the target functionality section to distinguish among target functionalities found in the current scan result, the comparison scan result, or both. For instance, as shown in FIG. 8, the application scanning service system 104 displays the “added” visual indicia (e.g., a first color highlight) for the target functionality 830 found (for the first time) in the current scan result (e.g., last seen in the version 2.32.0). Furthermore, as shown in FIG. 8, the application scanning service system 104 displays the “removed” visual indicia (e.g., second color highlight and stricken-through text) for the target functionality 832 found in the comparison scan result (e.g., found in a previous scan result, version 2.31.3, but not in the current scan result, version 2.32.0).

Moreover, as shown in FIG. 8, the application scanning service system 104 displays a target functionality 828 with the “no change” visual indicia (e.g., no highlight and no stricken-through text) due to detecting the target functionality 828 in the current scan result (e.g., version 2.32.0) and the comparison, previous scan result (e.g., 2.30.0). In addition, the application scanning service system 104 can indicate a last seen version indicator for the detected data processing activity components (e.g., the target functionalities). For example, as shown in FIG. 8, the application scanning service system 104 displays a last seen version of 2.30.0 for the target functionality 828.

Although some aspects herein illustrate utilizing strikethroughs and highlights to indicate changes in between application code version scans, the application scanning service system 104 can display various visual indicators to indicate the changes. For instance, the application scanning service system 104 can underline added data processing activity components, data types, and/or data categories. In some cases, the application scanning service system 104 can utilize symbols (e.g., exclamation points, arrows, plus or minus signs) to indicate a data processing activity component modification(s), data type modification(s), and/or a data category modification(s).

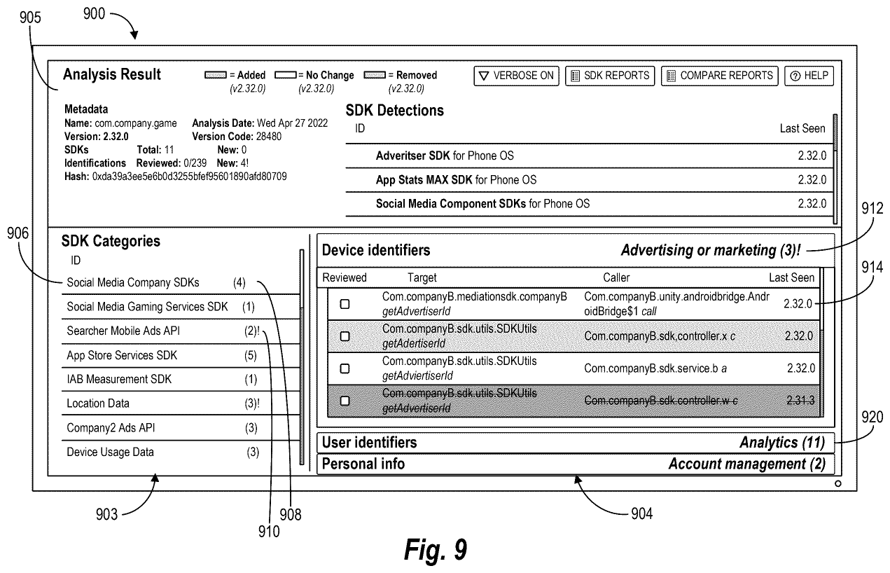

Furthermore, in some instances, the application scanning service system 104 can display identified data processing activity components from an application code categorized by SDK categories. For example, FIG. 9 illustrates the application scanning service system 104 generating, for display within a client or computing device, a graphical user interface to display categorized dynamic scan results from an application scan of an input application (or application code). For instance, the application scanning service system 104 generates, for display within a computing device 900, a graphical user interface 905 that includes a metadata section, an SDK detection section, an SDK category section 903, and a target detections section 904 for a scan of an input application (or application code).

For instance, the application scanning service system 104 can provide, for display within the graphical user interface 905, an SDK category section 903 that displays a list of SDK categories detected for the selected version of the input application. For example, the application scanning service system 104 can populate the SDK category section 903 by determining and displaying a set of categories (e.g., SDK categories by data types, data processing purpose types, SDK groupings, API groupings, developers, data processing activity component owners). For example, as shown in FIG. 9, the application scanning service system 104 displays, as an SDK category 906, an indication that the application code includes SDKs from “Social Media Company SDKs” (e.g., a developer or owner of one or more SDKs in the application code). Furthermore, as shown in FIG. 9, the application scanning service system 104 displays a count 908 of a number of SDK components detected for the SDK category 906.

In one or more cases, the application scanning service system 104 generates the SDK categories displayed in the SDK category section 903 as selectable interface elements. Indeed, upon selection (e.g., user selection) of an SDK category within the SDK category section 903, the application scanning service system 104 can display one or more data processing activity components from the application code (for the selected SDK category) in the target detections section 904.

As further shown in FIG. 9, the application scanning service system 104 can provide, for display within the graphical user interface 905, indicators to represent changes in components for one or more SDK categories in the SDK category section 903. As illustrated in FIG. 9, the application scanning service system 104 displays an indicator 910 to indicate a change in a number of data processing activity components detected in an application code for a particular SDK category (e.g., “Searcher Mobile Ads API” category). Indeed, the application scanning service system 104 can display various indicators for the SDK categories to indicate changes in SDK categories and/or an addition of new SDK category detected within a version of the application code.

Furthermore, as shown in FIG. 9, the application scanning service system 104 provides, for display within the graphical user interface 905, a target detections section 904. In particular, as illustrated in FIG. 9, the application scanning service system 104 displays, within the target detections section 904, a hierarchical list of SDK categories and target functionalities from the current scan result. For instance, as shown in FIG. 9, the application scanning service system 104 can display, within the target detections section 904, an SDK category 912 (e.g., SDK components with a purpose type of “advertising or marketing” for processing a data type of “device identifiers”) detected in the application code and the target functionalities 914 (e.g., data processing activity components) that are present in the application code that fall under the SDK category 912.

As further shown in the target detections section 904, the first level of the hierarchy includes SDK categories found in the scan results (with a version indicator for the application code version the SDK categories were found in). Moreover, as illustrated in the target detections section 904, the application scanning service system 104 can display a second level of the hierarchy that includes, for each SDK category, the target functionalities (e.g., data processing activity components) for that SDK category found in the scan results. As further shown in FIG. 9, the application scanning service system 104 can display closed hierarchical SDK categories (e.g., SDK category 920) and, upon receiving a user interaction with the closed hierarchical SDK categories, can expand the closed hierarchical SDK categories to display one or more data processing activity components for the closed hierarchical SDK categories.

Indeed, the application scanning service system 104 can display a variety of graphical user interfaces to display data, such as, but not limited to, scan results through application code metadata, SDK detections, data processing activity components organized by data types (or categories) and/or SDK categories, data processing activity component modifications, version updates, selectable options, exportable files as described in application Ser. No. 18/490,344.

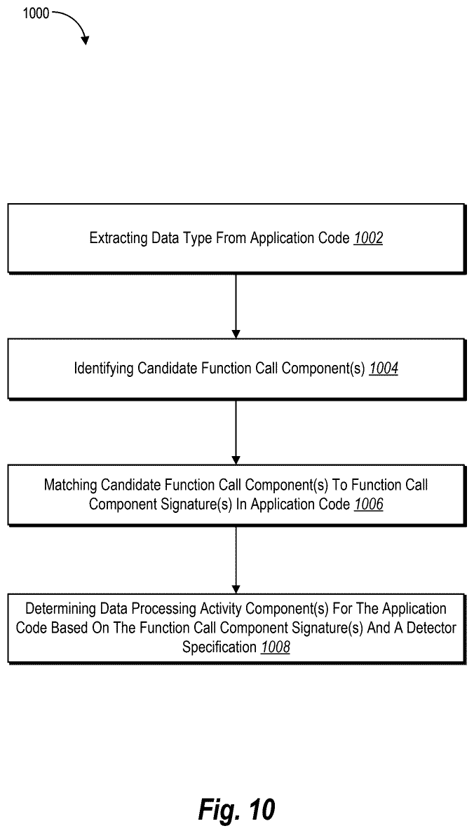

FIGS. 1-9, the corresponding text, and the examples provide a number of different methods, systems, devices, and non-transitory computer-readable media of the application scanning service system 104. In addition to the foregoing, one or more aspects can also be described in terms of flowcharts comprising acts for accomplishing a particular result, as shown in FIG. 10. The acts shown in FIG. 10 may be performed in connection with more or fewer acts. Further, the acts may be performed in differing orders. Additionally, the acts described herein may be repeated or performed in parallel with one another or parallel with different instances of the same or similar acts. A non-transitory computer-readable medium can comprise instructions that, when executed by one or more processors, cause a computing device to perform the acts of FIG. 10. In some aspects, a system can be configured to perform the acts of FIG. 10. Alternatively, the acts of FIG. 10 can be performed as part of a computer implemented method.

For example, FIG. 10 illustrates a flowchart of a series of acts 1000 for scanning an application code to determine data processing activity components for the application code in accordance with some aspects. While FIG. 10 illustrates acts according to one aspect, alternative aspects may omit, add to, reorder, and/or modify any of the acts shown in FIG. 10.

As shown in FIG. 10, the series of acts 1000 include an act 1002 of extracting a data type from an application code, an act 1004 of identifying a candidate function call component(s), an act 1006 of matching the candidate function call component(s) to a function call component signature(s) in the application code, and an act 1008 of determining a data processing activity component(s) for the application code based on the function call component signature(s) and a detector specification.

In one or more aspects, the series of acts 1000 can include extracting, by processing hardware, a data type from an application code based on a scan of the application code, identifying, by the processing hardware, utilizing the extracted data type, one or more candidate function call components, matching, by the processing hardware, the one or more candidate function call components to components from the application code to identify one or more function call component signatures from the application code, and determining, by the processing hardware, one or more data processing activity components for the application code by utilizing mappings for the identified one or more function call component signatures within a detector specification.

Furthermore, the series of acts 1000 can include transmitting an application code scan request to an application scanning service system to scan an application code by causing the application scanning service system to utilize a data type extracted from the application code to identify one or more candidate function call components and determine one or more data processing activity components for the application code based on one or more function call component signatures within the application code that match the one or more data processing activity components and a detector specification and, based on receiving the one or more data processing activity components for the application code, providing, for display on a graphical user interface, a software profile for the application code indicating the one or more data processing activity components.

In addition, the series of acts 1000 can include receiving an input application code with a scan request from a client device, extracting a data type from the application code based on a scan of the application code, identifying utilizing the extracted data type, one or more candidate function call components, matching the one or more candidate function call components to components from the application code to identify one or more function call component signatures from the application code, determining one or more data processing activity components for the application code by utilizing mappings for the identified one or more function call component signatures within a detector specification, and providing, for display within a graphical user interface of the client device, the one or more data processing activity components present in the application code within a software profile of the application code.

In some cases, the series of acts 1000 can include extracting, by the processing hardware, the data type by utilizing a code parser to identify the data type within the application code. In some aspects, the series of acts 1000 include extracting, by the processing hardware, a personal identifiable information data type, a location data type, a media data type, a device identifier data type, an application activity data type, a user identifier data type, an application performance data type, or an electronic communication data type from application code based on the scan of the application code. Furthermore, the series of acts 1000 can include transmitting the application code scan request to cause the application scanning service system to extract the data type by utilizing a code parser to identify the data type within the application code, wherein the data type comprises a personal identifiable information data type, a location data type, a media data type, a device identifier data type, an application activity data type, a user identifier data type, an application performance data type, or an electronic communication data type. In addition, the series of acts 1000 can include extracting the data type by utilizing a code parser to identify a personal identifiable information data type, a location data type, a media data type, a device identifier data type, an application activity data type, a user identifier data type, an application performance data type, or an electronic communication data type from application code based on the scan of the application code.

Moreover, in some instances, the series of acts 1000 include identifying, by the processing hardware, the one or more candidate function call components by selecting a candidate function call component based on the extracted data type from a mapping between candidate function call components and data types.

In addition, the series of acts 1000 can include utilizing, by the processing hardware, a pattern matching model to match the one or more candidate function call components to the one or more function call component signatures from the application code. In some cases, the series of acts 1000 can include matching the one or more candidate function call components to components from the application code to identify the one or more function call component signatures from the application code.

Furthermore, the series of acts 1000 can include determining, by the processing hardware, the one or more data processing activity components by selecting a data processing activity component from the detector specification that maps to a detector specification entry for a function call component signature from the one or more function call component signatures. In some cases, the series of acts 1000 can include determining the one or more data processing activity components for the application code by utilizing mappings for the identified one or more function call component signatures from the detector specification. For example, a detector specification entry can include at least one of a namespace for the function call component signature, a scanning identifier for the function call component signature, a data processing description for the function call component signature, a data type, or a functionality type. Additionally, one or more data processing activity components can include a software development kit (SDK) component, an application programming interface (API) component, or a function call component.

Moreover, the series of acts 1000 can include determining, by the processing hardware, a vulnerability flag corresponding to the one or more data processing activity components, wherein the vulnerability flag indicates a security flaw or technical flaw for the one or more data processing activity components.

In addition, the series of acts 1000 can include providing, by the processing hardware, for display within a graphical user interface, the one or more data processing activity components present in the application code within a software profile of the application code. In one or more aspects, the series of acts 1000 include providing, for display on the graphical user interface, the software profile for the application code indicating the one or more data processing activity components in relation to the data type and one or more additional data processing activity components identified in the application code in relation to an additional data type.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 depicts an example of a computing system 1100 that can be used for performing the operations described herein. One or more devices depicted in FIG. 1 (e.g., a server system 102, a client computing system 106, etc.) can be implemented using the computing system 1100 or a suitable variation.

The computing system 1100 can include processing hardware 1102 that executes program code 1105 (e.g., an analysis engine or other component of an application scanning service of the application scanning service system 104). The computing system 1100 can also include a memory device 1104 that stores one or more sets of program data 1107 (e.g., a data processing activity component library 108, a client repository 116 with input application code 118, etc.) computed or used by operations in the program code 1105. The computing system 1100 can also include and one or more presentation devices 1112 and one or more input devices 1114. For illustrative purposes, FIG. 11 depicts a single computing system on which the program code 1105 is executed, the program data 1107 is stored, and the input devices 1114 and presentation device 1112 are present. But various applications, datasets, and devices described can be stored or included across different computing systems having devices similar to those depicted in FIG. 11.

The depicted example of a computing system 1100 includes processing hardware 1102 communicatively coupled to one or more memory devices 1104. The processing hardware 1102 executes computer-executable program instructions stored in a memory device 1104, accesses information stored in the memory device 1104, or both. Examples of the processing hardware 1102 include a microprocessor, an application-specific integrated circuit (“ASIC”), a field-programmable gate array (“FPGA”), or any other suitable processing device. The processing hardware 1102 can include any number of processing devices, including a single processing device.

The memory device 1104 includes any suitable non-transitory computer-readable medium for storing data, program instructions, or both. A computer-readable medium can include any electronic, optical, magnetic, or other storage device capable of providing a processor with computer-readable instructions or other program code 1105. Non-limiting examples of a computer-readable medium include a magnetic disk, a memory chip, a ROM, a RAM, an ASIC, optical storage, magnetic tape or other magnetic storage, or any other medium from which a processing device can read instructions. The program code 1105 may include processor-specific instructions generated by a compiler or an interpreter from code written in any suitable computer-programming language, including, for example, C, C++, C#, Visual Basic, Java, Python, Perl, JavaScript, and ActionScript.

The computing system 1100 may also include a number of external or internal devices, such as an input device 1114, a presentation device 1112, or other input or output devices. For example, the computing system 1100 is shown with one or more input/output (“I/O”) interfaces 1108. An I/O interface 1108 can receive input from input devices or provide output to output devices. One or more buses 1106 are also included in the computing system 1100. The bus 1106 communicatively couples one or more components of a respective one of the computing system 1100.

The computing system 1100 executes program code 1105 that configures the processing hardware 1102 to perform one or more of the operations described herein. The program code 1105 includes, for example, the one or more applications described herein with respect to FIGS. 1-10 (e.g., the application scanning service, the analysis engine, the development application, the client application, etc.). The program code 1105 may be resident in the memory device 1104 or any suitable computer-readable medium and may be executed by the processing hardware 1102 or any other suitable processor. The program code 1105 uses or generates program data 1107.

In some implementations, the computing system 1100 also includes a network interface device 1110. The network interface device 1110 includes any device or group of devices suitable for establishing a wired or wireless data connection to one or more data networks. Non-limiting examples of the network interface device 1110 include an Ethernet network adapter, a modem, and/or the like. The computing system 1100 can communicate with one or more other computing devices via a data network using the network interface device 1110.

A presentation device 1112 can include any device or group of devices suitable for providing visual, auditory, or other suitable sensory output. Non-limiting examples of the presentation device 1112 include a touchscreen, a monitor, a separate mobile computing device, etc. An input device 1114 can include any device or group of devices suitable for receiving visual, auditory, or other suitable input that controls or affects the operations of the processing hardware 1102. Non-limiting examples of the input device 1114 include a recording device, a touchscreen, a mouse, a keyboard, a microphone, a video camera, a separate mobile computing device, etc.

Although FIG. 11 depicts the input device 1114 and the presentation device 1112 as being local to the computing device that executes the program code 1105, other implementations are possible. For instance, in some implementations, one or more of the input devices 1114 and the presentation device 1112 can include a remote client-computing device that communicates with the computing system 1100 via the network interface device 1110 using one or more data networks described herein.

While the present subject matter has been described in detail with respect to specific implementations thereof, it will be appreciated that those skilled in the art, upon attaining an understanding of the foregoing, may readily produce alterations to, variations of, and equivalents to such implementations. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. Accordingly, the present disclosure has been presented for purposes of example rather than limitation, and does not preclude the inclusion of such modifications, variations, and/or additions to the present subject matter as would be readily apparent to one of ordinary skill in the art.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Implementations of the methods disclosed herein may be performed in the operation of such computing devices. The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing some aspects of the present subject matter. Any suitable programming, scripting, or other type of language or combinations of languages may be used to implement the teachings contained herein in software to be used in programming or configuring a computing device. The order of the blocks presented in the examples above can be varied—for example, blocks can be re-ordered, combined, and/or broken into sub-blocks. Certain blocks or processes can be performed in parallel.

What is claimed is:

1. A computer-implemented method comprising:
extracting, by processing hardware, a data type from an application code based on a scan of the application code;
identifying, by the processing hardware, utilizing the extracted data type, one or more candidate function call components;
matching, by the processing hardware, the one or more candidate function call components to components from the application code to identify one or more function call component signatures from the application code; and
determining, by the processing hardware, one or more data processing activity components for the application code by utilizing mappings for the identified one or more function call component signatures within a detector specification.

2. The computer-implemented method of claim 1, further comprising extracting, by the processing hardware, the data type by utilizing a code parser to identify the data type within the application code.

3. The computer-implemented method of claim 1, further comprising identifying, by the processing hardware, the one or more candidate function call components by selecting a candidate function call component based on the extracted data type from a mapping between candidate function call components and data types.

4. The computer-implemented method of claim 1, further comprising utilizing, by the processing hardware, a pattern matching model to match the one or more candidate function call components to the one or more function call component signatures from the application code.

5. The computer-implemented method of claim 1, further comprising determining, by the processing hardware, the one or more data processing activity components by selecting a data processing activity component from the detector specification that maps to a detector specification entry for a function call component signature from the one or more function call component signatures.

6. The computer-implemented method of claim 5, wherein the detector specification entry comprises at least one of a namespace for the function call component signature, a scanning identifier for the function call component signature, a data processing description for the function call component signature, a data type, or a functionality type.

7. The computer-implemented method of claim 1, wherein the one or more data processing activity components comprise a software development kit (SDK) component, an application programming interface (API) component, or a function call component.

8. The computer-implemented method of claim 1, further comprising determining, by the processing hardware, a vulnerability flag corresponding to the one or more data processing activity components, wherein the vulnerability flag indicates a security flaw or technical flaw for the one or more data processing activity components.

9. The computer-implemented method of claim 1, further comprising extracting, by the processing hardware, a personal identifiable information data type, a location data type, a media data type, a device identifier data type, an application activity data type, a user identifier data type, an application performance data type, or an electronic communication data type from application code based on the scan of the application code.

10. The computer-implemented method of claim 1, further comprising providing, by the processing hardware, for display within a graphical user interface, the one or more data processing activity components present in the application code within a software profile of the application code.

11. A non-transitory computer-readable medium storing executable instructions which, when executed by a processing device, cause the processing device to perform operations comprising:
transmitting an application code scan request to an application scanning service system to scan an application code by causing the application scanning service system to:
utilize a data type extracted from the application code to identify one or more candidate function call components; and
determine one or more data processing activity components for the application code based on one or more function call component signatures within the application code that match the one or more data processing activity components and a detector specification; and
based on receiving the one or more data processing activity components for the application code, providing, for display on a graphical user interface, a software profile for the application code indicating the one or more data processing activity components.

12. The non-transitory computer-readable medium of claim 11, wherein the one or more data processing activity components comprise a software development kit (SDK) component, an application programming interface (API) component, or a function call component.

13. The non-transitory computer-readable medium of claim 11, wherein the operations further comprise transmitting the application code scan request to cause the application scanning service system to extract the data type by utilizing a code parser to identify the data type within the application code, wherein the data type comprises a personal identifiable information data type, a location data type, a media data type, a device identifier data type, an application activity data type, a user identifier data type, an application performance data type, or an electronic communication data type.

14. The non-transitory computer-readable medium of claim 11, wherein the operations further comprise transmitting the application code scan request to cause the application scanning service system to:
identify the one or more candidate function call components by selecting a candidate function call component based on the extracted data type from a mapping between candidate function call components and data types;
match the one or more candidate function call components to components from the application code to identify the one or more function call component signatures from the application code; and
determine the one or more data processing activity components for the application code by utilizing mappings for the identified one or more function call component signatures from the detector specification.

15. The non-transitory computer-readable medium of claim 11, wherein the operations further comprise providing, for display on the graphical user interface, the software profile for the application code indicating:
the one or more data processing activity components in relation to the data type; and
one or more additional data processing activity components identified in the application code in relation to an additional data type.

16. A system comprising:
one or more non-transitory computer readable media; and
processing hardware configured to cause the system to:
receive an application code with a scan request from a client device;
extract a data type from the application code based on a scan of the application code;
identify utilizing the extracted data type, one or more candidate function call components;
match the one or more candidate function call components to components from the application code to identify one or more function call component signatures from the application code;
determine one or more data processing activity components for the application code by utilizing mappings for the identified one or more function call component signatures within a detector specification; and
provide, for display within a graphical user interface of the client device, the one or more data processing activity components present in the application code within a software profile of the application code.

17. The system of claim 16, wherein the processing hardware is configured to cause the system to extract the data type by utilizing a code parser to identify a personal identifiable information data type, a location data type, a media data type, a device identifier data type, an application activity data type, a user identifier data type, an application performance data type, or an electronic communication data type from application code based on the scan of the application code.

18. The system of claim 16, wherein the processing hardware is configured to cause the system to identify the one or more candidate function call components by selecting a candidate function call component based on the extracted data type from a mapping between candidate function call components and data types.

19. The system of claim 16, wherein the processing hardware is configured to cause the system to utilize a pattern matching model to match the one or more candidate function call components to the one or more function call component signatures from the application code.

20. The system of claim 16, wherein the processing hardware is configured to cause the system to determine the one or more data processing activity components by selecting a data processing activity component from the detector specification that maps to a detector specification entry for a function call component signature from the one or more function call component signatures, wherein the detector specification comprises to detector specification entries comprising at least one of namespaces for function call component signatures, scanning identifiers for the function call component signatures, data processing descriptions for the function call component signatures, data types, or functionality types.
